(19) United States
(12) Patent Application Publication
(10) Pub. No.: US 2025/0069458 A1
(43) Pub. Date: Feb. 27, 2025

(54) ASSET-BASED, USER-PRESCRIBED ACCESS CONTROL AND PREMISES MANAGEMENT SYSTEM

(71) Applicant: Sclera Holdings, LLC, Wheeling, IL (US)

(72) Inventors: Vikram HEGDE, Prospect Heights, IL (US); Rajath Rao KANANGOLA, Prospect Heights, IL (US); Shrinivas HEBBAR, Karnataka (IN)

(21) Appl. No.: 18/453,231

(22) Filed: Aug. 21, 2023

(51) Int. Cl. G07C 9/27

(52) U.S. Cl. CPC G07C 9/27; G07C 2209/04

(57) ABSTRACT

A premises management system operates within a premises network to control access to information about assets or locations within the premises. The system receives a user identifier associated with an individual user from a user device and authenticates access rights of the user to connect with the system based upon the user identifier. The system further identifies a role of the user based upon the user identifier. The system further receives a unique identifier from a scan by a user device of a smart code physically associated with one of the assets or locations. The system identifies permissions held by the user to access information related to the selected asset or location based upon a combination of both the role and the unique identifier. The system requests information related to the selected asset or location from a data storage device connected to the network. A storage location of the information on the data storage device is associated with the unique identifier. A subset of the information about the asset or location is received from the data storage device limited to information authorized for release to the user based upon the permissions. The subset of the information about the asset or location is transmitted to the user device.

### TECHNICAL FIELD

The technology presented herein is generally directed toward a method to streamline workflow, monitor operations, and provide individualized accessibility via tag scanning for a plurality of assets and locations in a premises.

### BACKGROUND

With the proliferation of network-connected functional assets, for example, fire alarm and suppression systems, HVAC systems, security systems, access authorization systems, telecommunication systems, etc., integrated into premises such as hotels, hospitals, schools, office buildings warehouse facilities, etc., along with personnel performing in innumerable functions to operate and maintain the same, the task of facility management has become complex and hence the conventional approach to maintenance and operations can fall short. First, there is often a lack of customized access control, resulting in a one-size-fits-all approach that compromises security and restricts operational efficiency. Without individualized access, there is limited accountability and traceability regarding asset usage and changes. It becomes challenging to identify who accessed an asset, when, and for what purpose, hindering effective asset management and maintenance. Second, the absence of streamlined work order ticket generation hampers collaboration and task allocation, leading to delays, miscommunication, and inefficient workflow management. Third, without a centralized database for storing and updating changes to systems or individual assets, data integrity is compromised, making it challenging to access real-time information and hindering effective decision-making. Moreover, the absence of extensive data processing capabilities limits system functionality, impeding comprehensive reporting, analytics, and historical tracking. This can also result in data breaches, theft, or tampering with valuable assets.

Existing methodologies for premises management rely on manual or semi-digital data processing. However, many of these solutions lack interoperability with other systems or fail to integrate smoothly with existing infrastructure. This leads to fragmentation and complexity in managing access permissions across multiple systems or platforms, diminishing the overall effectiveness of individualized user access control. Many existing methodologies also lack the ability to dynamically adapt access permissions based on changing personnel roles, clearances, or specific requirements. As personnel responsibilities evolve or organizational structures change, access control mechanisms may struggle to keep pace, resulting in either excessive or insufficient access permissions, especially across multi-complex premises or organizations.

One proposal for digital, role-based access control (RBAC) does provide a layer of customization. While RBAC determines who can access certain assets or modules within the facility or premises, it does not inherently provide mechanisms for storing changes made by personnel or granting permissions to modify assets. RBAC primarily focuses on controlling read and write access to data or functionalities without incorporating the tracking or logging of changes made by individual personnel. Additionally, RBAC does not inherently include a workflow management component that enables the generation of tickets across different departments based on personnel permissions. RBAC's primary function is to provide access control based on predefined roles, rather than facilitating collaboration or task allocation across multiple teams or departments.

The information included in this Background section of the specification, including any references cited herein and any description or discussion thereof, is included for technical reference purposes only and is not to be regarded as subject matter by which the scope of the invention as defined in the claims is to be bound. The subject matter discussed in the Background section should not be assumed to be prior art merely because of its mention herein. Similarly, a problem mentioned in this Background section or associated with the subject matter of the Background section should not be assumed to have been previously recognized in the prior art.

### SUMMARY

The example implementations disclosed herein relate to systems and methods for utilizing a dynamic contactless scanning technology for implementing a computerized maintenance management system (CMMS) in facility management systems (FMS). The CMMS aids in optimized vendor and resource management by associating a unique, electronically-perceptible identifier, e.g., a quick-response (QR) code or unique identifier data stored in a near field communication (NFC) antenna tag (hereinafter referred to as “smart codes”), with, and affixing to, an asset or location within the facility. By leveraging unique identifiers associated with different personnel, the system establishes secure and dynamic connections with a centralized database, retrieves individualized access rights and privileges based on the person's role, clearance level, or specific requirements. This streamlined approach ensures seamless access control, granting authorized personnel tailored permissions to assets or locations within the facility while maintaining a high level of security and traceability. The system eliminates the disparity between personnel for an improved user, tenant, and guest experience while seamlessly handling all operations, procedures, and schedules for each time-intensive process by keeping priority tasks in check.

In an example implementation, a method is provided within a computer system connected within a network for controlling access to information about one or more assets or locations within a premises. The method includes receiving within a premises management system operating on the network a user identifier associated with an individual user from a user device; authenticating access rights of the user to connect with the premises management system based upon the user identifier; identifying a role of the user based upon the user identifier; receiving a unique identifier from a scan by the user device of a smart code physically associated with one of the assets or locations; identifying permissions held by the user to access information related to the one of the assets or locations based upon a combination of both the role and the unique identifier associated with the one of the assets or locations; requesting information related to the one of the assets or locations from a data storage device connected to the network, wherein a storage location of the information on the data storage device is associated with the unique identifier; receiving a subset of the information about the one asset or location from the data storage device limited to information authorized for release to the user based upon the permissions; and transmitting the subset of the information about the one asset or location to the user device.

In another example implementation, a premises management system is disclosed for controlling access to information about one or more assets or locations within a premises. The system includes a local area network associated with the premises; a proxy computer communicatively connected to the local area network; a data storage device communicatively connected to the local area network; an access control device, including a computing processor and a memory device, connected to the local area network and configured to securely manage access to and communication within and across the local area network, wherein the memory storage device is configured with instructions which, when executed by the computing processor, cause the computing processor to receive a communication over the local area network from a user device within the premises a user identifier associated with an individual user; authenticate access rights of the user to connect with the premises management system based upon the user identifier; identify a role of the user based upon the user identifier; receive a unique identifier from a scan by the user device of a smart code physically associated with one of the assets or locations; identify permissions held by the user to access information related to the one of the assets or locations based upon a combination of both the role and the unique identifier associated with the one of the assets or locations; request information related to the one of the assets or locations from a data storage device connected to the network, wherein a storage location of the information on the data storage device is associated with the unique identifier; receive a subset of the information about the one asset or location from the data storage device limited to information authorized for release to the user based upon the permissions; and transmit the subset of the information about the one asset or location to the user device.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments and implementations and illustrated in the accompanying drawings.

### BRIEF DESCRIPTION OF DRAWINGS

In conjunction with the accompanying drawings, the following detailed description provides an in-depth comprehension of the embodiments of the present disclosure. The drawings display the various methods, systems, and aspects related to the disclosure, and assigned elements in reference to the numerals stay consistent. The illustration of the embodiments and their functionalities serve as a visual aid in better understanding the disclosed premises management system.

The illustrated element boundaries (e.g., boxes, groups of boxes, or other shapes) in the Figures represent examples of the boundaries. In some examples, one element may be designed as multiple elements, or multiple elements may be designed as one element. In some examples, an element shown as an internal component of one element may be implemented as an external component in another and vice versa. Furthermore, the elements may not be drawn to scale. Similar designations may denote similar elements.

Various embodiments are described in accordance with the appended drawings, which are provided to illustrate, not limit, the scope and are not intended to indicate any preference or requirement for an illustrated embodiment to the exclusion of embodiments described with reference to that.

FIG. 1 is a schematic diagram depicting an exemplary embodiment of an infrastructure design including various attributes and information sets of a plurality of networked devices and providing user-based access for monitoring and managing the network installation.

FIG. 2A is a schematic diagram depicting an exemplary implementation of a plurality of assets and locations in a premises network, each associated with a unique smart code for enabling customized access to respective asset specifications, attributes, and functions.

FIG. 2B is a schematic diagram depicting an exemplary implementation of tagged assets and locations associated with a smart code to facilitate simplified asset and resource management across facilities.

FIG. 3 is a schematic diagram depicting example unique user profiles granted access to and provided with a customized subset of information for a combination of assets and locations within a premises.

FIG. 4 is a flow diagram depicting an example implementation of segmented user access control in a premises leveraging QR code integration as smart codes for efficient resource, asset, and data management.

FIG. 5 is a flow diagram depicting an example method for scanning an asset, indicating the distinct access level, functionality, and asset information provided specific to the user for a specific asset.

FIG. 6 is a schematic diagram of exemplary components of computer devices used to implement the asset-based, user-prescribed access and premises management system as disclosed herein.

### DETAILED DESCRIPTION

The technology disclosed herein includes system designs and corresponding methods for utilization of asset-specific smart codes for user-specific access and customized information provision to one or more of a plurality of assets within a building, campus, facility, or other premises (hereinafter “premises”). Examples of assets are typically related to infrastructure devices and may include, but are not limited to, HVAC systems, lighting controllers, audio-visual equipment, lock and access systems, security and video surveillance systems, water heaters, gas and electricity systems, network devices, building automation, appliances, Wi-Fi infrastructure, cellular network boosters, access control, fire panels, hospitality television systems, and telephony systems. Examples of premises include, but are not limited to, hotels, hospitals, school buildings, airports, manufacturing facilities, residential complexes, office buildings, warehouses, restaurants, shopping malls, and other commercial complexes.

Implementations of the system utilize smart code technology, e.g., QR code or NFC tag scanning, to provide individualized access control and information to different users within facility management. Each asset in the premises is communicatively coupled within a local area network (LAN) of the premises. The LAN may be implemented behind a gateway or network access device (e.g., a router or other network address translator (NAT) device). Each asset within the premises is also associated with a defined set of information via the smart code. Such information can include, but is not limited to, device model information, attributes, real-time status readings, maintenance checklists, maintenance history, repair instructions, repair history, and other documentation, all managed in a central database connected to the LAN, either locally or via connection through a wide area network (WAN), e.g., the internet). An access control device may be communicably coupled with the plurality of assets connected on the LAN, either directly or via one or more switches, to capture operational data from the connected assets. The access control device and methods implemented thereby are related to the concepts disclosed in PCT Publication No. WO2022013719A1 and U.S. patent application Ser. No. 18/338,163, which are hereby incorporated by reference as fully set forth herein and which may be referred to for background and understanding of the present disclosure. Users can scan smart codes on assets or locations using a personal computing device such as a smartphone, which sends the smart code information to the access control device connected within the LAN.

The access control device regulates the relevant information for different users with respect to their access to the premises and specific assets connected to the premises LAN. The access control device can authenticate the user based upon identification information associated with the personal computing device. For example, a system user may login to a software application on the personal computing device using a secure identifier, e.g., a username and password, or biometric authentication. The software application facilitates a scanning operation for a smart code, e.g., by using the user device camera to read a QR code or user device NFC functionality to communicate with an NFC tag on the asset. The software application can control network access technology of the personal computing device, e.g., WIFI® or Bluetooth® transceivers to connect to the LAN and communicate with the access control device. The access control device can be configured to grant access to a particular set of information relevant to the asset associated with the smart code based upon the role of the user. The access control device limits network access of an individual user to only permitted assets; no other assets on the network are visible to or accessible by that particular user. Access rights may be time-limited or cease upon completion of an operational, maintenance, or repair activity by the user and may be retracted at any time by an administrator.

The system configuration and control software of the premises management system enable individualized workflow management for users, analytics and performance reporting, asset monitoring, history analysis, and cross-department coordination among other functionalities. The premises management system enables seamless collaboration and efficient execution of workflows, while real-time monitoring of assets provides up-to-date asset information. The premises management system can enhance efficiency and coordination in premises management by offering individualized access and information based on user roles and contributions. The processes of tracking, monitoring, and troubleshooting is simplified for each user, thereby enhancing the experience for any user. The premises management system streamlines management and operations for premises owners, managers, and end-users, personalizing the workflow for each individual for proactive maintenance of each asset located on the premises. The disclosed premises management system ensures the security and privacy of the data stored and collected, while providing full user-specific access to features of assets as granted based upon the user's role and credentials.

The disclosed premises management system and related methods allow individual users to generate smart codes and implement use of the same by physically affixing them to (or adjacent to) and logically associating them with an asset or a location within the premises, without requirement for procedural training to set up, install, and use. Based on the requirement of the FMS and the amount of data that needs to be stored, either a QR code or an NFC tag can be utilized according to need. An NFC tag typically has lower storage capacity in comparison to QR codes. Low-capacity NFC tags are limited to storing URLs, contact information, relevant numerals, etc., and are useful for small data transfers. However, the memory storage capacity of the NFC can vary with different versions available on the market and some NFC tags can store similar amounts of data as the data density in a QR code. Further, some NFC tags are rewritable and could thus be reused for identification of different assets. In contrast, the data recorded in a QR code image is static. Some formats for QR codes can be secure (SQR), ensuring that only scanners of authorized users can decode the information contained in the SQR. Depending upon data density needed for asset identification, either NFC tags or QR codes can adequately function as smart codes in example implementations of the premises management system. However, other technologies such as bar codes or radio frequency identification (RFID) chips could also be used as smart codes if the data storage requirement is small.

The technically robust premises management system offers a unique approach to facility management through aggregation of asset information related to the unique smart codes. The access control device can provide a smart code management module for managing the association between assets or locations and smart codes, allowing administrators to easily modify, add, or remove tags with respect to assets or locations as needed. Use of smart codes associated with specific assets offers the authorized users access to real-time data and updates and provide asset-specific information like repair instructions, warranty details, maintenance history, scheduled inspections, associated work orders, and much more. Tagging assets with smart codes allows for more efficient supervision, monitoring, tracking, and maintenance of assets. Furthermore, the premises management system can provide information in the form of trends, historic data, manuals, certifications, audits, checklists, policies, reports, and analysis of the asset to appropriate users at the right time. Users on the premises, e.g., maintenance personnel, can access the information and functions of the asset or location through the associated smart code and easily troubleshoot a problem with the asset or trigger a maintenance process associated with the asset. Asset management is simplified and maintenance, service, and issue resolution are prioritized, thereby preventing asset failures and facilitating quick response time of vendors, technicians, or other personnel in charge or associated with maintaining or fixing the asset.

The disclosed premises management system combines smart codes with customized permissions to provide access control by tailoring permissions based on user roles, clearances, or specific requirements, ensuring fine-grained security and streamlined operations. The access control device efficiently can authenticate user logins seamlessly, providing a secure control mechanism for asset access based on authority granted in view of the smart code scanned and the user role.

Incorporation of data processing capabilities also enables generation of work order tickets upon scanning the smart codes. The work order tickets serve as centralized hubs, facilitating efficient collaboration and task allocation. For example, tickets may be generated for users across multiple departments upon a smart code scan, not just for the user that scanned the smart code, depending upon an issue or maintenance within their roles. Further, maintenance tickets can be automatically generated across departments according to a maintenance schedule, but actions performed by a user may be limited by clearance level or role upon scanning the smart code on the asset.

Users can access the tickets through a dashboard in a software application, e.g., on a smartphone or other portable digital device, view assigned tasks, update statuses, add comments, attach files, or mark tasks as completed. All updates, changes made, and data entered by users is securely stored and seamlessly updated in a centralized database, ensuring data integrity and providing real-time access to up-to-date information. The predefined access capabilities designated for different users, in conjunction with the access control device, results in a secure environment with access and use tracing and tracking, thereby minimizing the possibility of data breaches. This synchronized database serves as a reliable source of information for authorized users, allowing them to make informed decisions based on the most recent data. Furthermore, the data processing capabilities of the premises management system allow for the generation of tailored content identifiers or locators, such as destination URLs, contact information, video data, coupons, and more. The stored data can also be leveraged for reporting, analytics, and historical tracking (including visualizations such as graphs or trends), providing valuable insight into maintenance and repair trends, performance metrics and indicators, and opportunities for process improvements. Overall, the disclosed premises management system empowers facilities to optimize their asset and location management, enhance operational efficiency, promote effective collaboration, and enable data-driven decision-making within the facility management ecosystem.

A facility manager may be consumed with answering all the requests of personnel or end-users through multiple channels like emails, calls, or work orders requiring much time and effort to manage. This tedious process risks the chance of unintentionally delaying or overlooking a ticket or service request, potentially causing adverse effects and serious consequences. The premises management system targets these loopholes by automating tasks and allowing the facility managers to emphasize guiding and monitoring the facility to optimally function at any given point in time. In implementations disclosed here, problems of data misplacement, displacement, and misinformation are addressed by a methodical system that functions between users by storing continuous data of the asset in the access control device for future reference by other users. Checklists, inventory management, asset management, database maintenance, service request tracking, and ticket monitoring are integrated through the use of the asset smart codes providing dynamic access to information and controls depending upon the user.

As noted, the access control device serves as the central hub for managing access and information across the premises. The access control device is connected to a network infrastructure, including core and subnetwork switches, that enables communication with various devices, sensors, and locations within the premises. This network infrastructure may consist of wired or wireless connections, ensuring seamless data flow. Many assets include internal system monitoring and network connectivity, thereby allowing for connection with the access control device, which continuously monitors and captures real-time readings from the assets. This allows for the premises workflow system to ingest and organize precise and accurate data. Other data can be entered manually into the system by authorized personnel, ensuring that crucial information is recorded even if it cannot be directly measured.

Assets (electronic and non-electronic) and locations within the premises can be tagged with a unique smart code. These smart codes provide links to comprehensive information relevant and specific to the asset including, for example, historical analysis, performance metrics, repair requests, documentation, checklists for specific tasks or actions, etc. When a user scans a smart code on an asset with a with an application on a personal computing device, asset identification information stored in the smart code and user identification information corresponding to the user login on the personal computing device is transmitted to the access control device. The access control device identifies the role of the user to determine the user's level of access and the specific information they are authorized to view. For example, an engineer performing a performance analysis task on an HVAC unit would receive real-time readings, model information, and the last maintenance history, allowing the engineer to accurately assess the performance of the HVAC unit. Alternatively, a janitor scanning the same smart code would receive, for example, information related to filter cleaning or replacement records and a notice to refill an air freshener reservoir associated with the HVAC unit, as those tasks fall under janitorial responsibilities.

The premises management system can also include robust premises management capabilities. For example, if an engineer identifies a need for an intermediate cleaning of the HVAC unit, the engineer can send a request to the premises manager through the system application on a personal computing device. Upon receipt of the request, the premises manager, utilizing the premises management system functionality, can assign the task (e.g., a ticket) to an available janitor. This assignment triggers a notification to the janitor, who receives the request and any associated details, such as the location of the asset. Integrated floor maps of the premises can be included within the system to assist the janitor, e.g., by locating the position of the janitor and providing directions to the asset, minimizing the time and effort required to locate it. This is an exemplary embodiment intended to help with understanding of the disclosed premises management system in a simple context.

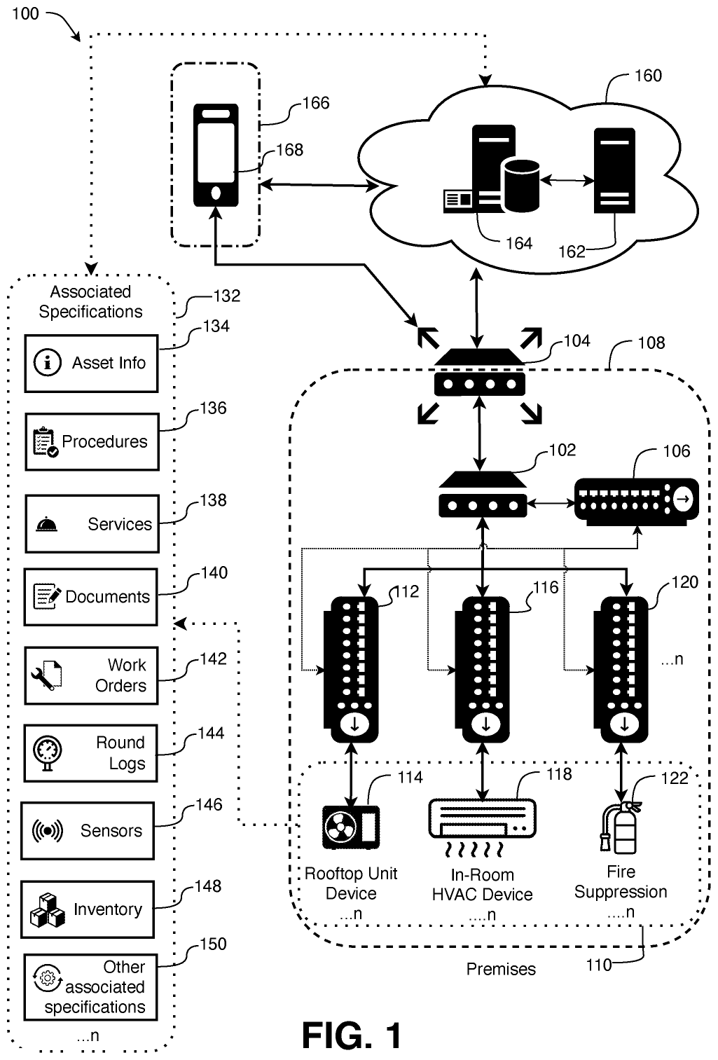

An example implementation of a premises management system 100 for a premises is illustrated in FIG.1. The premises management system 100 can include a local area network (LAN) 108 for the premises, an access control device 102 (as described above and further herein), and a network access device (NAD) 104, e.g., a modem or router/modem combination, for connection of the LAN 108 to an external or wide area network such as the Internet. The premises management system 100 further includes a plurality of resources, e.g., assets and locations, that may be integrated within a premises. Like assets can be collected in asset subnetworks 110 and connected to the LAN 108 through respective, intermediate subnetwork switches 112, 116, 120, which in turn are connected with the core switch 106 rather than directly to the access control device 102. The core switch 106, the subnetwork switches 112, 116, 120 are typically all connected together and the access control device 102 form the LAN 108 via wired connections (e.g., Ethernet), wireless access points (WAPs), network gateways, switches, etc.

For example, a first subnetwork switch 112 may be connected to a plurality of rooftop units (RTUs), e.g., heating, ventilation, and air conditioning (HVAC) systems or indoor air quality (IAQ) monitors for controlling and regulating temperature, humidity, and air quality on a premises, in an RTU subnetwork 114. A second subnetwork switch 116 may be connected to a plurality of in-room HVAC devices on a premises in-room HVAC subnetwork 118. A third subnetwork switch 120 may be connected to a plurality of sprinkler system controllers and fire extinguishers on a premises fire suppression system subnetwork 122 (e.g., an automatic fire suppression system (AFSS) network). It should be noted that the fire suppression subnetwork is an example of a network consisting of both networked devices (e.g., sprinkler controllers) and premises locations (e.g., locations of fire extinguishers). Additional subnetworks connecting additional premises systems to the access control device 102 for access by the premises management system 100 are possible as indicated. Therefore, the premises management system 100 is not limited to certain subnetworks and the application of the disclosed premises management system 100 may be utilized for the inclusion of myriad devices within the premises.

The particular asset subnetworks 114, 118, 122 represented in FIG. 1 and described herein are merely examples of possible networked systems forming asset subnetworks 110 on the premises. Any number of subnetwork switches may be utilized for monitoring a wide variety of premises systems collected in asset subnetworks 110, for example, computer servers, client computers, point of sale (PoS) systems, digital signage displays, audio and video systems, interface devices, telephone systems, IPTV management systems, energy management systems, lighting controllers, HVAC systems, RTUs, water boilers, audio-visual systems, closed-circuit television (CCTV) and security systems, keyless entry systems, building process management and automation, appliances, fire suppression systems, parking guidance and automation systems, etc. These asset subnetworks 110 can be linked to the access control device 102 and the core Ethernet switch 106 through subnetwork switches 112, 116, and 120. The connections can be established using different physical or wireless methods and protocols including, but not limited to, Ethernet, wireless local area network (WLAN), Near Field Communication (NFC), Bluetooth, Zigbee, Long Term Evolution (LTE), worldwide interoperability for microwave access (WiMAX), general packet radio service (GPRS), and other wired and wireless communication infrastructure and protocols.

The access control device 102 may communicate with a user device 168, such as a tablet, a smartphone, or other similar device, located on the premises through the NAD 104 connected within the premises LAN 108 or, if the user device 168 is at a remote location, by connection through an external network 166 with a remote computer server platform 160. The authentication of access and control by the user device 168 is handled by the remote computer server platform 160. This enables the premises operator or any designated end user to access the information from the access control device 102 to display the operational data obtained from the assets connected on the LAN 108 based on the configured permissions. The remote computer server platform can include one or more database servers 164 and one or more proxy servers 162 for receiving, storing, and providing requested asset data from and to the access control device 102 and managing communication traffic between the access control device 102, the database server 164, and remote user devices 168.

The remote server platform 160 in the premises management system 100 presented herein facilitates on-demand services delivered over the internet. Server computers on the remote server platform 160, for example, a proxy server 162 and a database server 164, typically managed and hosted by a cloud service provider, offer a scalable processing and storage resource tailored to meet the needs and the requirements of user authentication, asset and location identification, and data management for the premises management system 100. Data collected from each interaction with an asset or location associated with the same by scanning a corresponding smart code is transmitted to the remote server platform 160 via the access control device 102. Each is updated with relevant data in real-time such that information can be retrieved by authorized personnel on-demand ensuring an uninterrupted and reliable availability of data and services. The remote server platform 160 serves as a central, secure repository for effectively storing and managing data related to assets and locations within a premises, or multiple premises. The access control device 102 acts as an authenticator of users and a gateway to the remote server platform 160 to ensure secure and tailored access to data and information associated with a specific asset or location depending upon the authorization level or profile of each user.

The core Ethernet switch 106 FIG. 1 serves as a scalable, high-capacity, compact switch with central connectivity for interconnecting with the plurality of subnetwork switches 108, 112, and 116 and for aggregating asset subnetworks 110 for any premises environment. There is no limitation to the plurality of subnetwork switches 108,112, 116 that can be connected to the core switch 106 and implementations are not limited to the examples of asset subnetworks 110 shown. Any number of subnetworks can be connected and monitored simultaneously where data from each of the subnetwork switches can be transmitted at a time in real-time to the core switch 106. Functions of the assets connected to the LAN 108 can be locally monitored and controlled via an integrated management platform on the access control device 102. Alternatively, assets could be controlled directly by a user device 168 across the LAN 108 through separate control system software.

An integrated management platform on the access control device 102 may use a library of protocols and application programming interfaces (APIs) to communicate with all the assets on the subnetwork switches 108, 112, and 116, to display data stored pertaining to the systems of assets in the premises where the stored database may be relevant and specific to the person accessing the information. To ensure the proper functioning and working of the base-level functionalities of the assets on a premises, a manager or owner may associate specifications 132 for a device for the users. Each of the associated specifications 132 for an asset is different and customizable and access can be allocated to and individually limited with respect to one or more users. The associated specification 132 for each asset can be stored in a digital database, typically in the database server 164 on a related remote computer server platform 160 (i.e., cloud storage), but storage can also be locally provided, e.g., through a network-attached storage (NAS) device on the LAN 108 or other local physical storage media (hard disk or solid-state drives, etc.)

The access control device 102 securely processes the data of the assets or locations that are tagged to the unique smart code associated with each specific asset or location and customizes each user interface for each user irrespective of the networks and protocols used. The associated specifications 132 for a device or asset may include, but are not limited to, asset identification information 134, maintenance or repair procedure information 136, services 138, manuals and similar documents 140, work orders 142, maintenance round logs 144, sensor data 146, inventory information 148, and any number of other associated specifications 150. Numerous roles may be designated in an FMS such as administrators, facility managers, compliance managers, operations managers, engineers, technicians, vendors, janitors, occupants, end-users, etc. For example, a janitor's access privilege may be restricted to work orders 142 exclusively, where the focus is mainly on cleaning and maintenance. On the other hand, a technician's access may expand to maintenance round logs 144 and sensor data 146, enabling the technician to execute a comprehensive inspection, observe equipment functionality, and address other issues that may materialize.

The associated specifications 132 for an asset can include various relevant characteristics of that distinctive device for simplified resource and facility management. For example, the asset information 134 can include stored attributes such as identification codes, specifications, model numbers, maintenance history, service contracts, vendor data, and installation and expiry dates. Maintenance or repair procedure information 136 can include role-specific instructions for the specific device with checklists for service, inspections, or procedure management, alert protocols, repair instructions, completion dates, etc. Services 138 can refer to scheduled maintenance, repair tasks, scheduled, reactive and preventive services, and system upgrades, while documents 140 serve as a repository for user manuals, safety guidelines, attachments, technical specifications, and other similar documentation. Work orders 142 foster tracking and management of device-related tasks, while round logs 144 reflect database entries of dates and times of status readings from or interactions with the asset, e.g., from device sensors or manual input. The sensor data 146 includes collections of information from distinct device sensors which can include configuration, calibration, real-time measurement and units, threshold or historical values, and sensor health status. Inventory information 148 reflects the stock of asset-related resources, e.g., spare parts or replacements and quantities, locations, and usage history. Other additional associated specifications 150 tailored to specific devices and management roles and responsibilities can also be configured. Asset-related associated specifications 132 (e.g., for a fire extinguisher, information related to code, manufacturer and model, date of expiry, history of inspection and maintenance, service provider, etc.) can be stored on and retrieved from storage in the remote database server 164 for access by the user device 168 upon scanning the smart codes as further described herein.

Successful workflow management for maintaining assets within a premises is predicated on meticulous data management of possibly thousands of devices along with the history of their features, user manuals, graphical representations, and service and performance records, as well as system users and their roles. Typical FMSs require manual entry into and searching through a comprehensive digital database, encompassing a large array of roles associated with each asset or location to track interactions across vendors and multiple users, which is a laborious and time-consuming process. The access control device 102 is locally populated with or can access from the database server 164 accurate and comprehensive information on the asset or location that is associated with a unique smart code in the premises LAN 108. The physically installed plurality of assets in the subnetworks 110 can be connected through respective subnetwork switches 108, 112, 116 for data transmission either through the core switch 106 to the access control device 102 or directly to the access control device 102 depending upon the type of information being transmitted, the credentials of the user, or the nature of the network connection (e.g., from another device on the LAN 108 or from a remote network 106). Each asset placed on the premises LAN 108 is assigned a distinct identification with a unique IP address. The access control device 102 acts as a central access management hub between the assets and users and provides authorization for users to communicate with assets and places limits on the scope of such access and communication. By implementing the premises management system 100, the associated users such as administrators, technicians, and facility managers working can streamline task integrations and reduce response time delays and operational inefficiencies between multiple users.

Expanding upon the example of managing a plurality of RTU devices in an RTU subnetwork 114 in a premises as depicted in FIG. 1, associated asset-specific information 134 can include, for example, date of installation and expiry, manufacturer data, and locations of each unit in the facility. Procedure information 136 can include maintenance checklists. Services 138 can include scheduled maintenance, repair tasks, scheduled, reactive and preventive services, system upgrades, etc. Documents 140 can include device manuals and user guides. Work order information 142 can include contact information for contracted technicians or vendors as well as provide an active and historical ticket system for repair work. Round logs 144 can include history of prior services, inspections, etc., with comprehensive information about the repair chronology of each RTU unit in the RTU subnetwork 114. Sensor data 146 can be ingested to allow a facility engineer precisely monitor and track status of one of the RTUs on the RTU subnetwork 114 in real-time. Inventory information 148 can provide information about replacement parts on hand and supplier information for ordering parts not within a facility inventory.

The comprehensive data maintained for each RTU on the RTU subnetwork 114 within the associated specifications 132 enables users to track the upkeep and performance trends of individual RTUs, fostering informed decision-making on repair and replacement at an appropriate time. For each RTU, real-time data and measurements, such as temperature, pressure, humidity levels, energy consumption, and other appropriate parameters, are captured and stored for processing by the premises management system 100 implemented by the access control device 102. The analysis of sensor data can help optimize the performance and energy efficiency of an asset, provide valuable insights into the current operating status, and help identify inefficiencies, faults, historical records, and repair trends to inform proactive maintenance schedules and judicious decision-making for repair or replacement of individual assets, thereby driving appropriate part purchases for inventory and reducing potential downtime.

Similarly, for managing a plurality of indoor HVAC units on the indoor HVAC subnetwork 118 connected to the premises management system 100 within a premises, the associated specifications 132 can include device manufacturer, serial number, specifications, manuals and other documentation, maintenance history, and regular service schedules. As an additional example, a large number of fire extinguishers installed as part of a fire suppression system on a premises may not be communicatively connected within the fire suppression subnetwork 118 connected to the LAN 108 as other components of the fire suppression system can be (e.g., zoned sprinkler control systems), but the locations of fire extinguishers may be identified with a smart code. Additionally, the maintenance needs for fire extinguishers may be different than those of indoor HVACs and RTUs. For example, fire code and local government regulations may drive service requirements and related data collection and inventory management. Checklist management maintained as procedure information 136 for scheduled service checks and unit replacement may be primary activities with respect to fire extinguishers, as compared to sensor monitoring for RTUs and indoor HVACs, as well as sprinkler controls. Asset information 134 for premises fire extinguishers can contain accurate information regarding the number of fire extinguishers distributed on the premises along with their installation location. The inventory information 148 may be tied to expiration dates and to ensure adequate numbers of replacement devices are on-hand to switch out as required by code.

The premises management system 100 can incorporate role-based security protocols for presenting appropriate critical information based upon user-specific permissions for different personnel, such as vendors, facility managers, administrations, technicians, operators, end-users, etc. These protocols can prevent data breaches by unauthorized access and limit disclosure of sensitive information about the asset to authorized personnel. Only pertinent information based upon user identification and role is shared with a particular user, ensuring appropriate task assignments, easy collaboration, accountability of authorized personnel for privacy and security management. For example, the premises management system 100 can provide a customized user interface for each user on the application on their personal user device 168 based upon the user's role limited to need-to-know information for the role and particular asset identified through the smart code scan. Access to the database of asset information is limited to authorized personnel and further compartmentalized by role. Such can also improve efficiency in task completion and personnel accountability by preventing an unauthorized user to investigate unassigned issues and logging the interaction of each user with an asset in the corresponding rounds log 144.

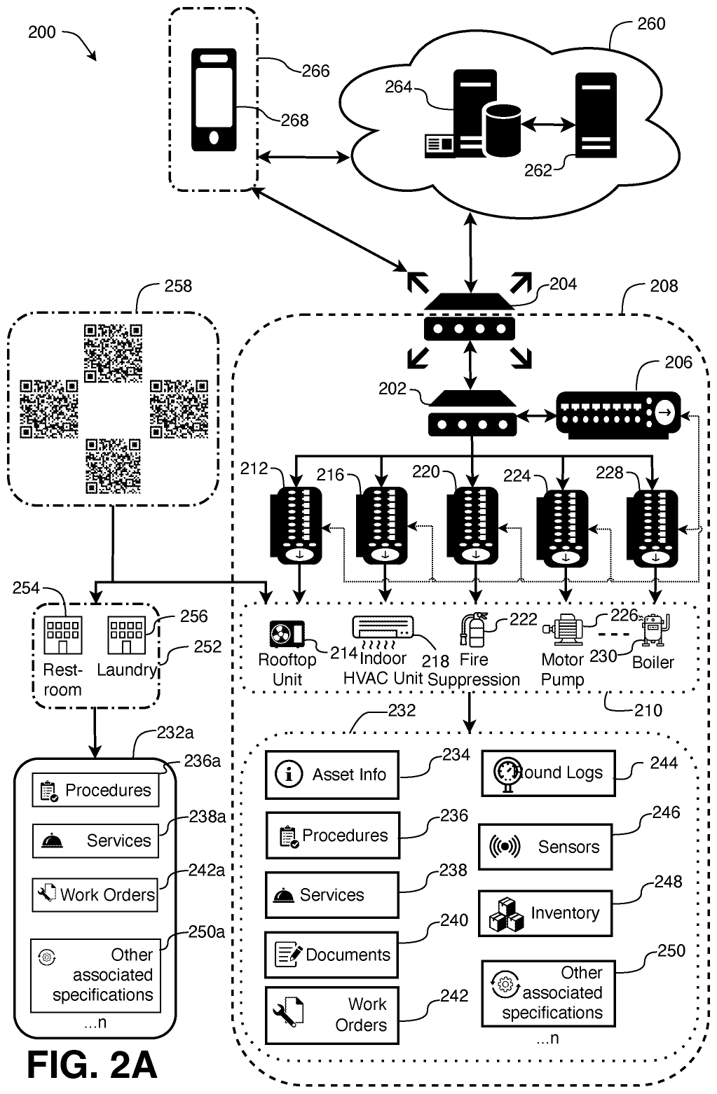

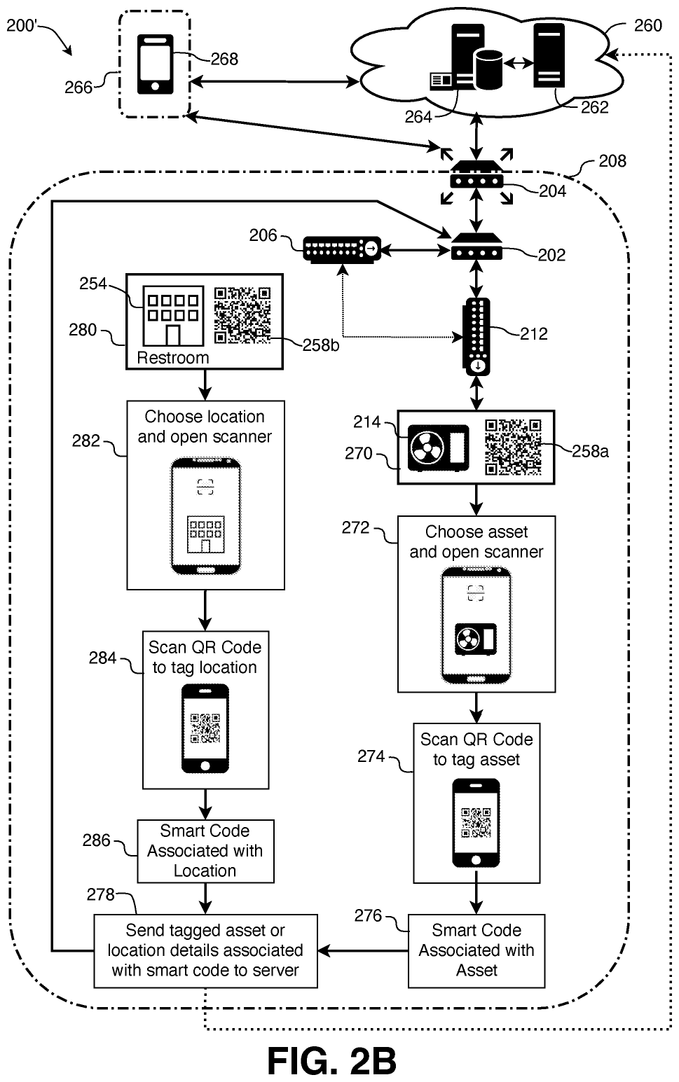

FIG. 2A is a schematic diagram of an example premises management system 200 implemented in a premises. The premises management system 200 includes an access control device 202 that is connected to a plurality of asset subnetworks 232 on the premises LAN 208 through multiple subnetwork switches 212, 216, 220, 224, and 228 and additionally through a core switch 206. The access control device 202 functions to limit access to the LAN 208 and any subnetworks thereon by users outside the network. However, internal network traffic can be handled through typical switching via the core switch 206, which is also connected to the subnetworks on the LAN 208. As indicated in FIG. 2A, various subnetwork switches 212, 216, 220, 224, and 228, may be connected to assets located within the premises, for example, assets communicatively connected through RTU subnetwork 214, indoor HVAC subnetwork 218, fire suppression subnetwork 222, motor pump subnetwork 226, and boiler subnetwork 230, respectively. As suggested by the example types of subnetworks, the attributes or functionalities exhibited by individual assets can diverge significantly. The premises management system collects, organizes, and maintains this disparate information and manages access to information related to individual assets by users assigned to execute specific operations with respect to such assets.

As indicated schematically in FIG. 2A, each of the plurality of assets connected via the subnetworks 210 is individually tagged with a respective, unique smart codes 258. In the example of FIG. 2A, the smart codes are depicted as QR codes. However, as described above, the smart codes can be implemented in NFC antennas, bar codes, RFID tags, or other similar identification technologies. The smart codes 258 provide network communication directions to stored data including both the locations of and specifications 232 for the assets. When onboarding large numbers of assets and locations in a premises and corresponding specifications or features associated with each asset or location, the smart codes can provide a unique identifier within the FMS infrastructure for that premises and a quick and easy way to associate and locate an asset in a particular physical location. The premises management system presented herein provides a centralized hub for monitoring, collecting, storing, and distributing information about the substantially varied assets and related characteristics in a complex data acquisition and management network.

Additionally, the premises management system, as implemented in software through the access control device 202, manages access of users to such specifications 232 and information related to specific assets and devices based upon the assigned roles or profiles of users. User requests for information about or access to an asset are implemented by scanning a smart code with a user device and providing the smart code information in conjunction with the user login information on a corresponding application or interface on the user device. The user is associated with the smart code of the asset to provide regulated, customized access to and information about the asset based upon user credentials and role.

The premises management system 200 is not limited to management of devices and sensors in a premises, but may also be applicable to locations 252 such as restrooms 254, laundries 256, storerooms, stairwells, or other areas within a premises that need to be maintained by personnel. Each location 252 can be marked with a smart code 258, e.g., as a sticker on a door, wall, or other surface at the location 252. Additionally, as described above, some physical assets subject to maintenance, e.g., fire extinguishers as part of a greater fire suppression system, are not capable of being part of a communication subnetwork. Each location 252 of such an asset can be associated with a smart code 258 for inclusion in the premises management system 200. For example, a subset of associated specifications 232a may be associated with locations rather than directly with assets capable of communicating with a network. Such specifications 232a can include procedures 236a, services 238a, work orders 242a, and other associated specifications 250a with respect to the location tagged to that unique smart code 258.

Similar to the presentation in FIG. 1, associated specifications 232 for each of assets in respective asset subnetworks 110, e.g., a RTU subnetwork 214, an indoor HVAC subnetwork 218, a fire suppression subnetwork 222, a motor pump subnetwork 220, and boiler subnetwork 224 may include one or more of asset information 234, procedure information 236, service information 238, documents 240, work orders 242, round logs 244, sensor data 246, inventory 248, and other associated specifications 250 relevant to a specific type of asset. For example, for RTUs in the RTU subnetwork 208 and indoor HVAC units in the indoor HVAC subnetwork 212, asset information 234 can include unique identification codes, model and serial numbers, installation date, warranty expiration date, manufacturer information, and other relevant descriptive attributes. Procedure information 236 can include documented instructions in the form of checklists pursuant to regulatory standards, guidelines, codes, calibrations, and other industry-specific requirements set forth by industry organizations or regulatory bodies. Service information 238 can include service and repair schedules as appropriate to the type of RTU or indoor HVAC unit, e.g., based upon manufacturer recommendations or regulatory or contractual requirements. Documents 240 related to RTU and indoor HVAC units can be stored for quick access and include user manuals and guides, technical specifications, engineering drawings, and warranty information to aid engineers, vendors, or other personnel in proper handling, installation, operation, maintenance, and repair of the RTU or indoor HVAC unit. Other documentation furnished by the manufacturer or by third-party vendors, or other personnel, e.g., including historical notes for review by later personnel interacting with the RTU or indoor HVAC unit may also be stored.

Work orders 242 can include tasks or specific instructions for personnel tagged to that specific RTU or indoor HVA unit, which may include scheduled routine maintenance identified in the services 238, reactive or preventive maintenance activities, repairs, and inspections. Scheduling and completion of each task is recorded and documented and can be analyzed as a group to identify common histories or trends. Various parameters for an RTU or indoor HVAC unit may be monitored by sensors and such sensor data 246 such as humidity, temperature, pressure, environmental conditions, energy consumption, airflow, etc., can be recorded, stored, and analyzed. The inventory 248 may include information regarding the description, number, and storage location of spare parts available for repair or replacement and supplies related to the RTU or indoor HVAC unit, e.g., filters and refrigerant, as well as reorder information and schedules to ensure the timely availability of necessary components to minimize asset downtime. Other associated specification 250 may be added as necessary by a premises manager to capture other relevant information, e.g., performance metrics or ratings or integrations with other premises systems, related to RTUs or indoor HVAC units on their respective subnetworks 214, 218. Premises operators can leverage this premises management system 200 to optimize energy efficiency, indoor air quality, and occupant comfort while maintaining, ensuring proper performance, and extending the lifespan of RTU and indoor HVAC systems in diverse facility settings.

In another example, e.g., in a fire suppression system subnetwork 222, similar but contextually different information may be collected and stored as associated specifications 232. For example, asset information 234 may be similar and include unique identification codes, model and serial numbers, installation date, warranty expiration dates (e.g., for fire extinguishers), manufacturer information, and other relevant descriptive attributes. Procedure information 236 can include instructions, checklists, and regulatory guidelines, which outline proper handling, maintenance, inspection procedures, and compliance with relevant safety standards and regulations. Documents 238 can include user manuals, safety data sheets, and specifications for assets of the fire suppression system. Work orders 242 can include task-directives for routine system tests, safety drills, sprinkler repairs, fire extinguisher refills and inspections, and fire and smoke alarm inspections and replacements. Each task can be tracked and recorded for maintenance history. Round logs 244 may be pertinent to fire extinguishers within the fire suppression subnetwork in particular. Sensor data 246 may be utilized to monitor and analyze critical parameters such as sprinkler control systems, water pressure, excessive temperature, or active status of smoke alarms. Inventory 248 can include comprehensive information on spare parts, refills, stock levels, and locations. Additionally, other associated specifications 250 provide other relevant details not included specifications for other assets and systems such as for communication connections with local fire departments.

As another example, associated specifications 232 for motor pumps in a motor pump subnetwork 226 are provided to aid efficient functioning, maintenance, and performance optimization. Asset information 234 identification codes, model and serial numbers, installation date, warranty expiration date, manufacturer information, and other relevant descriptive attributes. Procedure information 236 can include regulatory standards, guidelines, calibrations, and other functional product requirements. Services 238 can include service and repair schedules as appropriate. Documents 240 can include user manuals and specifications for use in troubleshooting and repair of devices. Work orders 242 can be developed using the task-specific instructions from the asset manuals to generate maintenance tickets at recommended intervals. Sensors 244 can be monitored in real-time and data can be collected on parameters of the motor, which may include energy consumption, temperature, flow, etc., to aid in the early detection of irregularities or potential failures. Inventory 248 can include information on the availability of fluids, lubricants, spare parts, components, etc., and storage locations for each to streamline maintenance processes of the asset. Other associated specifications 250 in the context of motor pumps may include efficiency standards, motor power ratings, etc., which may be stored in a separate application category or one of the prior specification areas described above.

In another example of an asset system in a premises, boilers for heating and energy generation can include sensors and communication interfaces within the LAN 208. A diverse range of associated specifications 232 can be collected and made available to assist premises users with efficient operation, maintenance, and safety of these essential heating devices. Asset information 234 for a boiler can include manufacturer information, model name and number, installation date, warranty expiration date, and other relevant descriptive attributes. Procedure information 236 can include documentation of operational guidelines, maintenance checklists, instructions, and safety protocols. Service information 238 can include a summary of service and repair schedules specific to each boiler type, size, make, and model in the premises. Documents 240 can include user manuals and guides along with technical drawings and specifications with safety certifications, and warranty information. Work orders 242 provide proactive resource allocation, and task-specific instructions like scheduled assignment of maintenance, needed repairs and services particular to the role of the premises personnel trained or designated to perform such task. Sensor data 246 may be collected from sensors associated with boilers and that are connected to the LAN 208. Sensor data received outside normal parameters may trigger alerts, for example, when the boiler reaches or exceeds threshold levels for combustion, temperature, pressure, fuel levels, emissions, etc. Inventory 248 can maintain information about boiler-specific needs such as fuel supply, water treatment chemicals, and other supplies, as well and the quantity and location of spare parts within the premises. Other associated specifications 250 may include boiler-specific information such as fuel type, combustion system, boiler capacity, heat output, control mechanisms, and integration capabilities to monitor and extend the life of the boiler.

As noted above in the discussion of fire extinguishers within a fire suppression system, smart codes can be assigned to “dumb” assets, i.e., assets that do not include network connectivity devices. In such cases, the smart codes can be placed on or near the asset to identify the location. As with networked assets, a large volume of information about static assets associated with a location 252, for example, laundry facilities 252 or restrooms 254 with in a premises, can also be collected, stored, and made available to premises personnel based upon their roles. As depicted on FIG. 2A, associated specifications 232 can include procedure information 236a including instructions for compliance with industry-specific codes, checklists for calibration and maintenance activities, cleaning guidelines for specific locations and materials, and identification of specific tools for use in related activities. Service information 238a can include scheduled maintenance and repair schedules, preventive service schedules, system upgrade deadlines, etc. Work orders 242a track and manage service activities and facilitate efficient resource allocation across the facility. Other associated specifications 250a can cover performance metrics, compatibility with control systems, integration with facility management systems, task list and resource management, activity log and status, attendance and availability of resources, etc. Premises managers and other users can leverage this comprehensive information collected and managed within the premises management system 200 to streamline, prioritize, and optimize routine checks at locations within the premises through customized interfaces based upon user roles as further described below.

Myriad assets and devices may be present in a premises with abundant information available. The scope of the premises management system 200 is not limited to the specific examples of assets described herein and extends to a broader range of assets or devices and can be tailored as required for a premises by an individual or an organization. The integration of smart codes 258 and the output derived from each of the specifications and operational and maintenance history for an asset identified by a smart code 258 helps the users or personnel to easily retrieve useful information to analyze the present status of the asset upon scanning the associated smart code. The premises management system 200 enhances the decision-making abilities of personnel while facilitating proactive measures by providing real-time insights into the performance metrics, operational status, and maintenance requirements of the assets.

Additionally, by collecting and interpreting a multitude of data points, including sensor readings, and asset-specific parameters, the premises management system 200 can process data to identify historical trends or underperforming assets, thereby empowering personnel to make informed decisions regarding asset management and optimization strategies. The premises management system 200 integrates analytics and machine learning algorithms, fostering predictive maintenance, anomaly detection, and data-driven optimization, thereby further enhancing the proactive management reliability, productivity, and longevity of the assets. Personnel can proactively address conceivable issues, optimize asset performance, and minimize response time and asset downtime, ultimately improving operational efficiency and reducing costs. Astute management of heterogeneous assets through networked assets and locations identified by smart codes optimizes productivity and streamlines operations.

FIG. 2B is a schematic diagram of premises management system 200′ and example process flows therein for a premises LAN 208 embodying a subset of the assets and locations depicted in the example of FIG. 2A. In FIG. 2B, unique smart codes are again employed in two distinct ways, i.e., to assets and locations. As depicted in this example, a unique smart code 258a can be tagged to an asset such as a RTU 214 within a subnetwork connected to a corresponding RTU subnetwork switch 212, to facilitate efficient tracking and management of the individual asset and providing access to asset-related functionalities. By scanning the unique smart code 258a using a hand-held user device 268, such as a smartphone or tablet equipped with a built-in scanner and a camera, users can access asset-specific details, e.g., from the database server 264 on the remote server platform 260. Such detail information can include, for example, maintenance procedures, technical details and specifications, service history, inspection records, user trends, asset status, and other associated pertinent data and documents. The user device 268 can connect to the access control device 202 via the LAN 208, if within the premises and so authorized to connect, or via the external network 266 by communication through the network access device 204. Similarly, a smart code 258b can be affixed to a specific location such as restroom 254, that permits users or personnel to scan the smart code 258b using a scanning application on the handheld device 268 to provide instant access to contextual, relevant, and specific information associated with that location, such as cleaning status, service and inspection records, work orders, history, etc.
authentication from the proxy server 262 on the remote server platform 260 and corresponding permissions stored in the access control device 202 pertaining to the scanned asset or location and thus a device is easily tagged for further operations and processes using the unique distinct smart code.

FIG. 2B presents two example process flows, one for associating a smart code with an asset and another for associating a smart code with a location. In the first process flow, the user associates a unique smart code 258a with an asset such as an RTU 214, for example, by affixing a unique smart code 258a directly to the RTU 214 (or other asset) as indicated in operation 270. Next, the user selects the respective asset type (e.g., a RTU) within a catalog of assets presented through a related application operating on the user device 268 as indicated in operation 272. When choosing the asset, the user may be prompted to enter information specific to that asset, for example, manufacturer, model, serial number, location within the premises, installation date, etc. The premises management system 200′ will then automatically associate information relevant to the selected asset type, e.g., manuals, technical specifications, maintenance schedules and procedures, etc., stored within the remote database server 264 with the record created for the asset, e.g., RTU 214. Upon selection and completion of profiling of the asset, the application on the user device 268 will activate a scanning functionality (e.g., a camera or a NFC signal) on the user device 268. The user then scans the unique smart code 258a newly associated with the RTU 214 using the user device 268 as indicated in operation 274.

The smart code 258a encodes a predetermined link or address to a record storage location within the proxy server 262 of the premises management system 200′. By scanning the smart code 258a in this set-up protocol, the premises management system 200′ further associates the smart code 258a with the asset, i.e., RTU 214, as indicated in operation 276. The association information between the smart code 258a address is then sent to the remote proxy server 262 for authentication as indicated in operation 278, ensuring the validity of the smart code 258a within the proxy management system 200′, and the specific asset information is further associated with the record storage location. In this way, the identification information entered for the asset, i.e., RTU 214, is accessible when the smart code 258a is later scanned, and general data (e.g., user manuals and similar documents), as well as specific data (e.g., maintenance schedules and repair records) can be associated with the record storage location and thereby with the asset. As indicated, the network access device 204 enables communication between the deployed access control device 202 and any hand-held client or user devices 268 hosted within the LAN 250 to transmit the association information to the remote server platform 260. Otherwise, if the user device 368 is connected through a remote network 266, the association details may be sent directly to the server platform 260 or to the network access device 204 to route the communication traffic to the remote server platform 260 through the access control device 202 for added security.

In the second process flow, the user associates a unique smart code 258b with a location in the premises such as a restroom 254, for example, by affixing a unique smart code 258b on the door of the restroom 254 (or other location) as indicated in operation 280. Next, the user selects the respective location type (e.g., a restroom 254) within a catalog of locations presented through a related application operating on the user device 268 as indicated in operation 282. When choosing the location the user may be prompted to enter information specific to that location, for example, room number, floor, particular building within a multi-building premises, etc. The premises management system 200′ will then automatically associate information relevant to the selected location type, e.g., maintenance schedules and procedures, supply inventory, etc., stored within the remote database server 264 with the record created for the location, e.g., restroom 254. Upon selection and completion of profiling of the location, the application on the user device 268 will activate a scanning functionality (e.g., a camera or a NFC signal) on the user device 268. The user then scans the unique smart code 258b newly associated with the restroom 254 using the user device 268 as indicated in operation 284.

The smart code 258b encodes a predetermined link or address to a record storage location within the proxy server 262 of the premises management system 200′. By scanning the smart code 258b in this set-up protocol, the premises management system 200′ further associates the smart code 258b with the location, i.e., restroom 254, as indicated in operation 286. The association information between the smart code 258b address is then sent to the remote proxy server 262 for authentication as indicated in operation 278, ensuring the validity of the smart code 258b within the proxy management system 200′, and the specific asset information is further associated with the record storage location. In this way, the identification information entered for the location, i.e., restroom 254, is accessible when the smart code 258b is later scanned, and general data (e.g., related regulations, protocols, and similar documents), as well as specific data (e.g., maintenance records, supply inventory, etc.) can be associated with the record storage location and thereby with the location. As indicated, the network access device 204 enables communication between the deployed access control device 202 and any hand-held client or user devices 268 hosted within the LAN 250 to transmit the association information to the remote server platform 260. Otherwise, if the user device 368 is connected through a remote network 266, the association details may be sent directly to the server platform 260 or to the network access device 204 to route the communication traffic to the remote server platform 260 through the access control device 202 for added security.

When a designated user scans the smart code associated with an asset or location, the proxy server 262 authenticates the user credentials and, upon successful authentication, customized information and functionalities relevant to the user role are retrieved from the database server 264 either through the access control device 202 if the user device 268 is connected to the LAN 208 or directly from the database server 264 if the user device 268 is connected via an external network 266. In some example configurations, the user device 268 may connect to the access control device 202 from the external network 266, which then connects to the remote server platform 260 to ensure added security for access to the LAN 208 and the external server platform 269. The access control device 202 securely communicates with the remote database server 264, retrieving asset information authorized for the role of the requesting user. The customized information is then transmitted to and displayed on the interface of the user device 268 by a cooperating local application on the user device 268, providing real-time access to the relevant asset details through scanning of the associated smart code 258a/b.

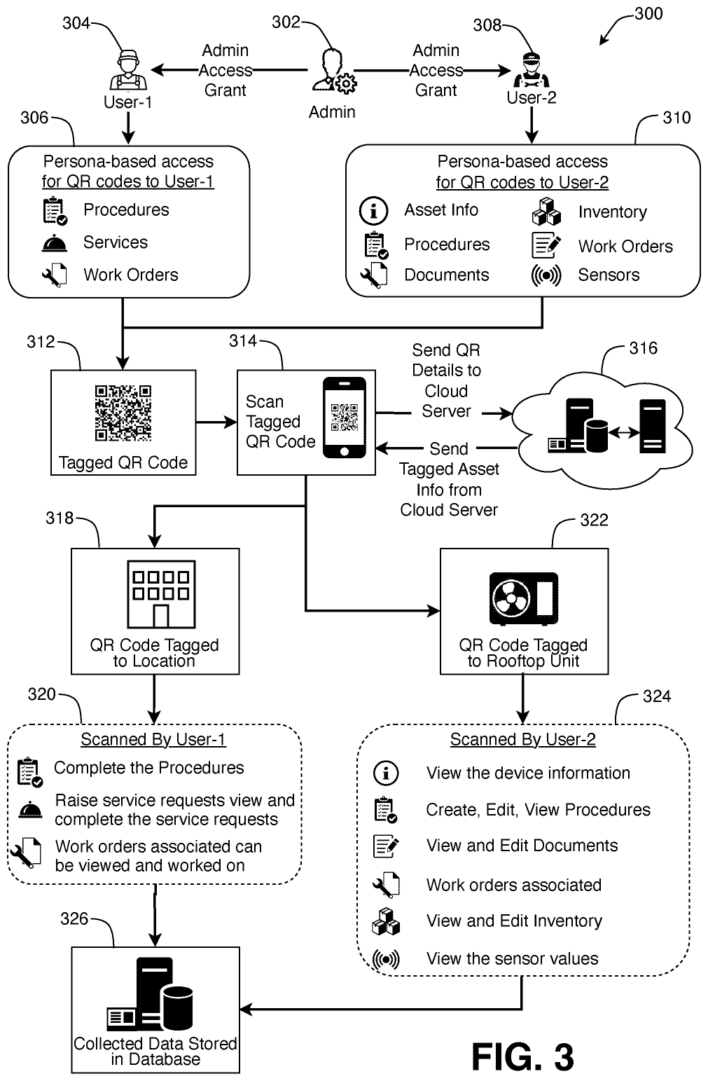

In an organization using CMMS, the role of an administrator is to manage user access, permissions, and resource allocation to ensure secure operations and optimized usage of each asset in the premises. Pre-defined Access Control Lists (ACLs) may be used to determine the detailed procedures or specifications that users or user groups can undertake within the system. ACLs typically consist of a list of permissions associated with multiple resources or actions. For example, an ACL might restrict a user or group to read-only access to certain files, restricting such users from revision or deletion of such files. ACLs thus help administrators fine-tune the level of access endowed to individual users or groups. As an added feature, the premises management system allows customization of the attributes associated with assets or locations. Administrators can configure the smart code to grant specific permissions and access levels to different user roles, which is further explained in FIG. 3. This customization assures that users, such as operators, administrators, technicians, vendors, engineers, facility managers etc., are provided with tailored features and information appropriate to their roles, thereby facilitating collaboration and enhanced operational efficiency between personnel.

FIG. 3 is a schematic representation of an example architecture of an ACL system 300 for implementing ACLs in an implementation of a premises management system as disclosed herein. The ACL system 300 stores and maintains user profiles, which can include information such as job roles, levels of authority, permissions, and preferences. The concept of user-based access assigns all users within an organization a distinct set of access requirements and privileges to resources, systems, or data governed by access control policies as set by the organization. The administrator 302 of the premises management system can tailor the roles, responsibilities, and preferences of a user to access asset-or location-related features through a simple dashboard interface by assigning access rights 306, 310 to individual users within an organization. As depicted, an administrator 302 grants individualized access rights 306, 310, e.g., individually configured through performance dashboards, to individual user profiles such as User-1 304 and User-2 308, respectively. These access rights 306, 310 are integrated with an asset and location smart code identification regime such that the access rights 306 for User-1 304 with respect to an asset or a location identified by a smart code 312 are different from the access rights 310 granted to User-2 308.

Users within the organization are assigned unique identifiers within the premises management system, for example, username or network logins, biometrics, multi-factor authentication, or any other unique identifier system or protocol implemented by the organization serving as user-authentication credentials. When logged into the premises management system through an individual user device, users can be notified through the application interface with a task or work order, for example, by in-app notifications, pop-up messages, e-mail notifications, tickets for services and inspection, short message service (SMS), etc. Corresponding navigation instructions can be provided to direct the user to the designated asset or location. For example, the application on the user device can provide a premise map and location plots to indicate paths in real-time and update accordingly as the user moves through the premises.

In one example, User-1 304 may be maybe a janitor, maintenance staff, outside vendor, or other user allocated significantly limited set of access rights 306 such as, for example, procedures, services, and work orders. Depending upon the role, these access rights 306 can include such things as viewing location information, review and complete assigned work orders, submitting work requests or maintenance tickets for services, reviewing scheduled inspections or manual checks, and accessing relevant documents, procedures, manuals, or guides specific to assigned tasks. User-1 304 may further have restrictions on modifying or editing location data, advanced configurations, or access to sensitive information to maintain security, prevent unauthorized actions, and ensure that User-1 304 operates within a designated scope of responsibilities.

In contrast, User-2 308 may be a technician, engineer, electrician, facility manager, or other user with greater privileges than User-1 304 and thereby assigned broader access rights 310, for example, to asset information, procedures, documents, inventory, work orders, and sensor data. For example, User-2 308 may have access to some or all of the information and functionality that User-1 304 has, and can have additional rights, for example, the ability to view detailed asset information, perform advanced configurations, initiate work orders, manage maintenance tasks, generate reports, conduct an in-depth analysis of the history of the asset before service, implement tracking of asset performance, access comprehensive documentation and procedures, etc. User-2 308 may also have permission to modify asset data, order parts, authorize replacement of malfunctioning assets, assign tasks to other users for troubleshooting, escalate requests to management, etc. While any user can scan a smart code associated with an asset or location, the user will only be afforded access to associated information pertinent to or limited by their role.

When the user scans 314 the smart code 312 related to an asset or location with a user device, the link or address information from the smart code 314 is sent to the proxy server in the remote server platform server 316. The proxy server authenticates the request and locates and aggregates related data from the database server authorized for presentation to or access by the user on a user device. The authorized, aggregated data, or links thereto, can be sent securely to the user device. Upon authentication of a user and presentation of an asset or location smart code 312, a session can be initiated to provide real-time data updates implement mechanisms such as data synchronization, event-driven updates, or periodic data refreshes to keep each user in sync with the coordination and tracking of tasks, processes, and approvals within the system for streamlined workflow modelling, task assignment, and tracking. The management systems in an organization can function conjointly and integrate with other enterprise systems, such as document management systems, customer relationship management (CRM) systems, or enterprise resource planning (ERP) systems, to exchange data, and trigger actions and services.

The scenario in FIG. 3 displays a smart code 312 associated with one of an asset or a location. With a smart 312 code associated with a location 318, such as a restroom or laundry, is scanned by User-1 304 as indicated in operation 320, only access to authorized data or privileges based upon the role assigned to User-1 304 are available. In this example implementation, the access rights 306 provided upon scanning the smart code 312 allow User-1 304 to view and complete procedures or inspections associated with the location 318, raise, view, and complete service requests, and view and mark complete related work orders. For example, with the authority to raise service requests, User-1 304 can report any issues or requirements related to the location 318 observed that User-1 304 has no ability or authorization to handle. As a further example, User-1 304 can review assigned tasks within, track progress of, and contribute to the completion of work orders pertaining to the designated location 318. Any data contributions made by User-1 304, for example, new service requests, checklist completions, completions of work orders, etc., can be collected and uploaded to the database server as indicated in operation 326.

In an alternate scenario depicted in FIG. 3, a smart code 312 associated with a RTU 318 can be scanned by User-2 308, who has a different role and different access rights 310 than User-1 304. In this example implementation, the access rights 310 afforded to User-2 308 can allow User-2 308 to view device information; view, create, and edit procedures; view and edit documents; view and address work orders; view and edit inventory information; and view sensor values associated with the RTU 322 as indicated in operation 324. These operations are in line with and restricted to the granted access rights 310, aligned with the assigned role of User-2 308 within the organization as determined by the administrator 302, which include asset information, procedures, documents, work orders, inventory, and sensor data. This enables User-2 308 to effectively interact with the RTU 322, execute instructed tasks, and access applicable data within the established boundaries of allocated permissions. As with actions related to the location 318, any data contributions made by User-2 308, for example, edited documents or procedures, edited inventory information, new service requests, checklist completions, completions of work orders, etc., can be collected and uploaded to the database server as indicated in operation 326.

The alignment of data access and privileges with user roles and groups through ACLs in an organization helps administrators enforce granular access control, reducing the risk of unauthorized access to prevent privacy and data infringements. This approach enhances security, simplifies administration, and ensures that users have the necessary permissions to perform their specific job functions efficiently, resulting in improved productivity, improved compliance and user productivity, and increased overall system integrity and user satisfaction.

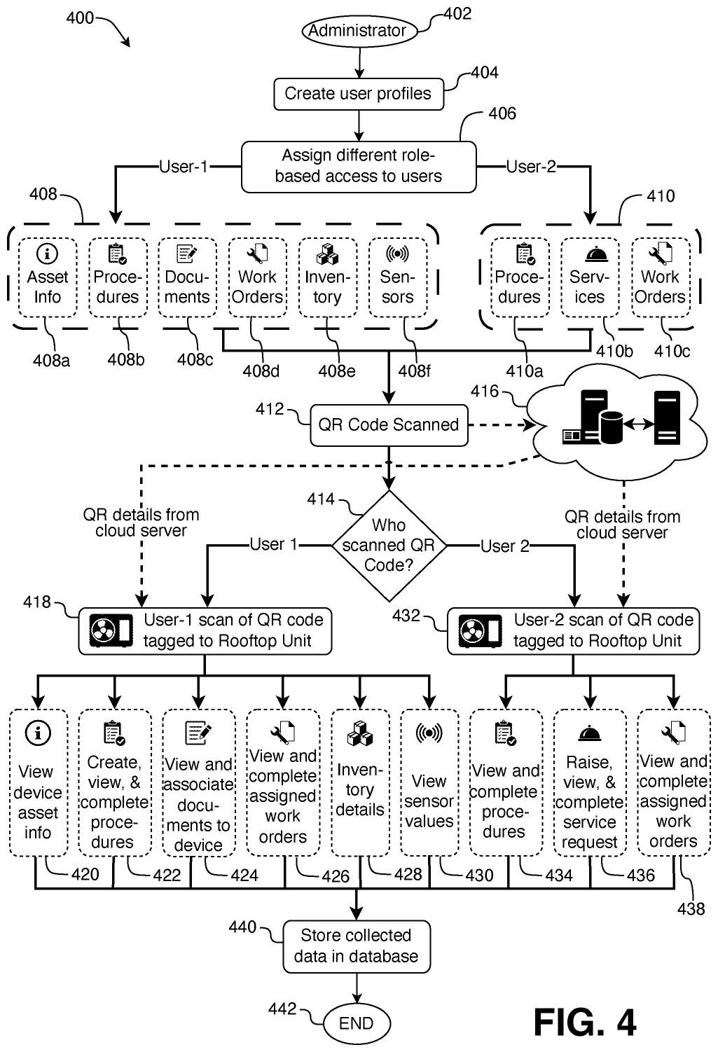

FIG. 4 is a flow diagram illustrating an example implementation of a process 400 for assigning and controlling access to assets and locations within a premises by users implemented by an access control device within the premises management system. The process 400 begins when an administrator 402 creates user profiles as indicated in operation 404 corresponding to different users within the premises. Each user profile is associated with a unique identifier, e.g., a network login, to facilitate individual access to the premises management system and tracking. The creation of user profiles and allocation of unique identifiers constitute the first step in establishing a role-based access control framework. Furthermore, the administrator 402 can define and manage the access permissions for each user profile, in addition to determining the scope of information and functionalities accessible to different roles. This administrative control ensures that users only have access to the relevant data and actions required for their specific tasks, fostering a secure and streamlined environment.

The administrator 402 then proceeds to allocate role-based access in operation 406 to the various user profiles created earlier. This allocation ensures that each user is granted access to the specific elements and functionalities within the premises management system that are relevant to their role and responsibilities. In the example of FIG. 4, User 1 is granted access to several data and function categories 408 related to a particular asset within the premises. These data and function categories 408 include asset information 408a, procedures 408b, documents 408c, work orders 408d, inventory information 408e, and sensor data 408f. User-1 can view and interact with these data and function categories 408, allowing User-1 to effectively manage and monitor the asset's performance, maintenance, and related activities within the scope of User-1's assigned role.

Likewise, User-2 is granted access to a different set of data and function categories 410 related to assets specific to their role and responsibilities. These data and function categories 410 can include procedures 410a, work orders 410b, and services 410c. As is apparent, the data and function categories 410 exposed to User-2 is both different and smaller than the data and function categories 408 exposed to User-1. Use-2 can access and work with these specific elements, enabling User-2 to efficiently handle tasks such as executing maintenance procedures, managing work orders, and coordinating services required for optimal facility management. By allocating role-based access to different user profiles, the administrator 402 ensures that each user has access to the relevant information and functionalities needed to carry out their specific responsibilities. This approach enhances efficiency, minimizes the risk of unauthorized access, and streamlines collaboration within the facility management framework.

In an example implementation, a user may be sent a notification through the premises management system and received by the user device for presentation by the corresponding application interface on the user device. The notification could be related to maintenance, cleaning, routine check-up, or any other relevant task assigned to a user. The notification specifies the asset or location that requires attention, and it may also provide navigation assistance using floor maps to guide the users to the designated area within the facility. Upon receiving the notification, User 1 and User 2 can interact with the application interface on their respective devices, navigate to the indicated asset or location, and use their device's camera to scan the QR code 412 attached to the asset. In another implementation, User-1 or User-2 may be in the vicinity of an asset or location and notice a need or problem (e.g., a restroom needing cleaning or an asset malfunction). The user may scan the associate smart code to input a work order request. In either case, the scanning process serves as a means of authentication and access to the asset's specific information and functionalities.

When either User-1 or User-2 scans a smart code attached to an asset or associated with a location, either in response to a notification or upon their own initiative, as indicated in operation 412, User-1 or User 2 establishes a connection between the physical asset or location and the premises management system. The premises management system initiates the authentication process through the proxy server on the remote server platform 416. This authentication can be performed using the unique user identifier associated with the user who scanned the smart code. The proxy server serves as a central authentication authority, verifying the user's identity and permissions. The premises management system authenticates the user identity and verifies the access privileges. Once the user's authentication is successfully validated, the premises management system proceeds to search for and retrieve customized information associated with the identified user based upon identity, role, and access permissions from the database server on the remote server platform 416 as indicated in operation 414. The premises management system can retrieve relevant asset or location details, such as real-time readings, maintenance history, repair requests, or any other pertinent information tailored to the roles and responsibilities of users. This streamlined process eliminates the need for manual search or navigation through the application for an asset, allowing users to quickly and efficiently access the specific asset information they require to perform their assigned tasks within the facility.

The customized information retrieved from the remote server platform 416 is passed through the access control device within the premises management system. The access control device acts as a gateway, connecting the remote server platform 416 securely to the assets connected to the LAN within the premises and to the user device. The access control device communicates with the remote server platform 416, retrieving the customized information and functionalities based on the user's authentication status and role. Updated data generated by the user, or by an asset connected to the LAN, also passes through the access control device to ensure secure communication and prevent unauthorized access to other assets or systems on the LAN. Such customized information can include retrieving asset-specific details such as real-time readings, maintenance history, repair requests, or any other relevant information associated with the scanned asset. By retrieving the individualized access elements, the system ensures that the user is presented with the precise set of information and functionalities required for their assigned tasks and responsibilities. This individualized retrieval of information enhances efficiency, streamlines workflow management, and allows users to access the relevant data in real-time, empowering them to make informed decisions and take appropriate actions within the facility management framework.

As an exemple, FIG. 4 depicts disparate information and access provided to User-1and User-2 when each scans a smart code associates the same RTU in a premises. When User-1 scans the smart code attached to the RTU as indicated in operation 418, the pemises management system identifies the user and classifies the permissions granted accordingly, which is represented by a set of attributes and functionalities flowing from operation 418. For example, upon successful authentication, User-1 can view RTU asset information 420, providing details such as model information, specifications, and location. User-1 can also create, view, and complete procedures 422 specific to the RTU, allowing User-1 to effectively manage and execute maintenance procedures, troubleshooting steps, or any other required tasks associated with the RTU. Furthermore, User-1 can view and associate documents 424 with the RTU, facilitating easy access to relevant documentation such as manuals, service records, or technical specifications. User-1 can also access and complete assigned work orders 426 for the RTU, enabling User-1 to efficiently handle tasks related to the maintenance and repair of the RTU, or handle other work orders specifically assigned to User-1. In addition, User 1 can access inventory details 428 for the RTU, allowing User-1 to monitor the availability of spare parts or consumables required for maintenance and promptly order replacements when necessary. Moreover, User-1 can view sensor values and stored data 430 from the RTU, enabling User-1 to monitor real-time readings such as temperature, pressure, or energy consumption of the RTU. By providing User-1 with access to these specific elements related to the RTU, the premises management system ensures that they have the necessary information and functionalities to effectively manage and maintain the RTU in line with their assigned role and responsibilities.

In contrast, when User-2 scans the smart code for the RTU as indicated in operation 432, User-2, whose access permissions are different from User-1, gains access to a different set of information and functionality relevant to the role of User-2 within the premises management system. Upon successful authentication, User-2 can view and complete procedures 432 for the RTU, for example, predefined steps for maintenance tasks, troubleshooting, or operational checks that User 2 is responsible for performing. By accessing and completing these procedures, User-2 can effectively carry out the assigned tasks related to the RTU. Additionally, depending on permissions granted to User-2′, the ability to raise, view, and complete service requests 436 related to the RTU may be provided. This functionality allows User-2 to report any issues, malfunctions, or maintenance requirements for the RTU, ensuring timely resolution and efficient management of service-related tasks. Furthermore, User-2 can view and complete assigned work orders 438 for the RTU. These work orders may include specific tasks, deadlines, and instructions assigned to User-2 for maintenance, repair, or other activities related to the RTU. By accessing and completing these assigned work orders, User-2 can contribute to the effective management and maintenance of the RTU within their assigned responsibilities. By providing User-2 with access to these specific elements and functionalities related to the RTU, the facility management system ensures that they can carry out their role effectively, collaborate with other team members, and contribute to the overall operational efficiency of the facility.

As indicated in FIG. 4, User-1 has access to a more numerous and comprehensive suite of data and functionality related to the RTU including asset information 420, procedures 422, documents 424, work orders 426, inventory details 428, and sensor values 430. This wide-ranging access suggests a role with significant responsibility for the overall functioning and maintenance of the RTU. User-1 could potentially be a facilities manager or a maintenance supervisor. This individual would require extensive knowledge of the workings of the RTU, the ability to monitor its status through sensor data, oversee inventory related to the RTU, handle relevant documentation, and perform or oversee necessary procedures.

User-2, on the other hand, has permissions that are narrower. User-2 has the ability to view and complete procedures 434 for the RTU, raise and oversee service requests 436, and view and complete assigned work orders 438. This level of access suggests a role that is more focused on hands-on maintenance and servicing of the RTU. User-2 could be a maintenance technician or service engineer, roles that require the ability to perform technical procedures, handle work orders, and coordinate external services as needed.

These roles are not exhaustive and the actual roles could vary based on the organizational structure and the specific responsibilities assigned to each user. However, the premises management system allows the administrator 402 to allocate permissions based on the specific needs and responsibilities of each role, ensuring efficient and secure operations.

Finally, after User-1 and User-2 have performed their tasks and interactions with the RTU, the premises management system captures all relevant data, including any changes made by the users, logs, and history, and updates the database as indicated in operation 440 in the remote server platform 416 through the access control device. This step ensures that a robust and accurate record of asset management activities is maintained for audit and analysis purposes. By updating the database with the latest information, the premises management system preserves a comprehensive history of asset-related activities, including maintenance procedures executed, work orders completed, service requests raised, and any modifications made to the asset configuration. This allows for detailed tracking, traceability, and accountability, which are used for compliance, performance analysis, and decision-making processes. Furthermore, the stored data enables retrospective analysis of asset performance, identification of recurring issues, and optimization of maintenance strategies. It also facilitates historical comparisons, trend analysis, and the ability to generate insightful reports that can guide future decision-making and improvements in asset management processes. By capturing and storing data within the database, the system ensures that a reliable and centralized repository is available for authorized personnel to access and retrieve relevant information whenever required. This not only aids in maintaining accurate records but also supports proactive decision-making, continuous improvement, and efficient asset management practices.

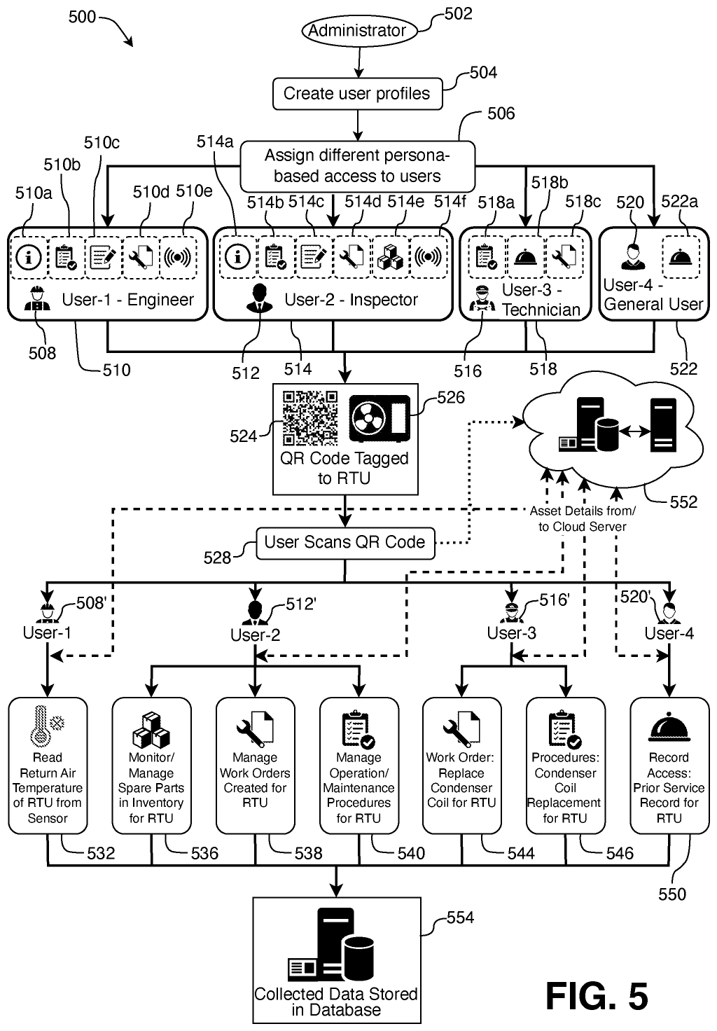

FIG. 5 is a relational flow diagram of an example process 500 of implementations of the premises management system presented herein depicting role-based access control through use of smart codes associated with an example asset. FIG. 5 highlights the strategic utilization of roles defined for different example users such as User-1 508, an engineer, User-2 512, an inspector, User-3 516, a technician, and User-4 520, a general user. The premises management system is designed to accommodate a wide range customization of user roles and permissions to access features and specifications. This approach ensures that the premises management system can be effectively implemented in diverse organizational settings and cater to unique access needs by utilizing various user profiles.

The Administrator 502 is responsible for creating a set of user profiles in operation 504, wherein each user profile has specific access controls and responsibilities as assigned by the Administrator 502. The Administrator 502 assigns each user to one or more specific user profiles that correspond to their roles and responsibilities as indicated in operation 506. Every user profile 504 is different and specific for the role or user associated with the specific user profile. One or more users can have similar roles and responsibilities, such as a team of technicians or a group of managers, such that a common user profile can be assigned to a group of users, thereby enabling efficient management of the entire user profile, eliminating the need to individually manage each user, and ensuring consistency in access privileges for users with similar responsibilities. Categorizing users into different roles based on predefined criteria, for example, through an access control list helps easily define the appropriate access privileges for each user. This integrated approach empowers organizations to optimize resource utilization, bolster asset security, and streamline data-driven decision-making, ultimately fostering enhanced operational efficiency within the facility.

Upon creation of a user profile and receiving a role-based access, User-1 508, in the example of FIG. 5, is granted specific access to certain information determined appropriate for an engineer regardless of the allocated asset or location. This is represented in the profile specifications 510 which include asset information 510a, procedures 510b, documents 510c, work orders 510d, and sensor data 510e. Relevant access, information, and function assigned to an engineering role such as held by User-1 508 can include access to advanced configuration settings, maintenance procedures, or specialized tools, resources, and comprehensive access controls, along with technical documents, providing them with in-depth information related to asset management etc. Similarly, for User-2 512, the profile specifications 514 for the inspector role can include asset information 514a, procedures 514b, documents 514c, work orders 514d, inventory 514e, and sensor data 514f. This allows User-2 512 to access and review crucial information related to asset inspections and quality control, ensuring compliance with organizational standards and regulatory requirements while monitoring inventory and asset data.

The User-3 516 profile specifications 518 for a technician are more limited and include procedures 518a, services 518b, and work orders 518c as their assigned specifications. These profile specifications 518 grant the User-3 516 access to detailed instructions for carrying out maintenance tasks, managing service requests, and efficiently completing assigned work orders. As a further example, User-4520 may be a general user with assigned profile specifications outlined in 522, which are limited to accessing services 522a. This general user profile grants the general user the ability to interact with and utilize various services offered within the organization in the form of checklists for relevant assets to assist with compliance for priority concerns and issues, simplifying the administrative tasks and effectively reducing the administrative burden.

FIG. 5 provides a particular example of how various users may interact differently with the same RTU 526 having an associated smart code 524. When each user scans the smart code 524 as indicated in operation 528, the interface presented to each user in the application on their respective user device reflects different tasks for monitoring and troubleshooting the RTU 526 relevant to the user who scanned the smart code 524. For example, when User-1 508′, the engineer, scans the smart code 524 associated with the RTU 526, the application directs User-1 508′ to check the sensor data 532 such as for return airflow and temperature output to ensure the RTU 526 is functioning properly and within norms. User-1 may also be presented real-time insights into the operational status, historical performance data, and other performance metrics of the RTU 526, enabling User-1 to make informed decisions and take appropriate actions for maintenance and troubleshooting. While User-1 508′ has been granted greater access, e.g., as indicated by the profile specifications 510, User-1 508 may choose not to exercise all access rights with respect to the RTU 526 at each encounter, but rather focus only on a particular repair need in a work order or maintenance item on a service calendar. Note also that all the permissions granted to a user in profile specification may not apply to or be relevant to every asset or location the user may encounter within the premises. The premises management system cross-references the user permissions and the existence of data associated with a scanned asset or location and provides relevant, regulated, and available information and access accordingly.

In another example, User-2 512′, an inspector, may be responsible for overseeing certain features or specifications such as monitoring and managing inventory 536 of spare parts used for maintenance and repair of the RTU 526. User-2 512′ is assigned access privileges and corresponding duties as depicted in the corresponding profile specification 514. Duties can include monitoring stock levels, tracking usage, and ensuring an adequate supply of necessary components for maintenance and repairs. Furthermore, User-2 512′ has the authority to manage and prioritize work orders 538 associated with the RTU 526. Such duties can include organizing and scheduling maintenance tasks, assigning tasks to technicians, and ensuring that all work orders are completed promptly and in accordance with established procedures. By closely monitoring the progress and status of work orders, the inspector maintains a streamlined workflow and enables efficient maintenance operations. To execute tasks effectively, User-2, as an inspector, is provided access to comprehensive procedures 540 that outline the step-by-step guidelines for replacing and repairing various parts of the RTU 526. These procedures serve as a resource, providing User-2 512′ with detailed instructions and best practices to ensure the correct and efficient execution of maintenance activities. By following these procedures, User-2 512′ can ensure that all repairs and replacements are carried out accurately, thereby minimizing downtime and optimizing the performance of the RTU 526 to enhance the overall efficiency, reliability, and longevity of the premises' HVAC system.

In another example, User-3 516′, a technician, can be assigned certain access privileges with respect to the RTU 526 and may be responsible for overseeing certain features or specifications of the RTU 526. For example, User-3 516′ may have the training to replace the condenser coil, a specialized task that requires specific expertise and adherence to precise procedures. Upon receipt of an assigned work order 544 for condenser coil replacement, with granted access rights associated with their profile, User-2 516′ can access comprehensive and detailed procedures 546 for condenser coil replacement for the specific model of the RTU 526, outlining each step (e.g., disassembling the RTU, handling the new condenser coil, making necessary connections, and performing the required tests to ensure functionality) necessary to complete the maintenance successfully. This available information helps ensure that the RTU 526 is maintained properly to operate optimally. Furthermore, access to these detailed procedures fosters consistency and standardization in the maintenance process. By adhering to the established protocols, technicians can confidently carry out their tasks, minimizing the risk of errors and maximizing the effectiveness of the maintenance operation.

In a further example, User-4 522′, a general user may be granted access to view service record information 550, e.g., for cleaning dirt, dust, and other contaminants, for the RTU 526. Such limited access conforms to the role of User-4, a general user, to stay updated on the maintenance history and ensure that the RTU 526 remains in a clean and well-maintained state. User-4 can use this information to plan and schedule future cleaning activities accordingly, e.g., by a technician like User-3, ensuring that the RTU-526 is consistently maintained and operates at its optimum performance. Thus, user access by role maintains cohesiveness in an organization between multiple users and user profiles. The database server on the remote server platform 552 is regularly updated with information about user activities directed to the RTU 526 as indicated in operation 554, ensuring that activity information, sensor date, and user information remains synchronized across the network within an organization.

The premises management system provides an efficient solution as a CMMS in a facility management system FMS by integrating management of a multiplicity of assets, locations, and personnel, saving time, effort, and money for a premises manager. The existing solutions for automating operations and maintenance have shortcomings that limit their widespread adoption. First, in the absence of smart code scanning, any facility manager must manually monitor all operations and assets, and manage multiple files, system platforms, and databases to obtain relevant information. The process is time-consuming, may limit accessibility, increase errors and inaccuracies, and also limit time spent on other critical operations, leading to inefficiencies in asset management. Second, in the absence of real-time monitoring without status updates, there can be a misalignment of information between vendors, managers, users, and other personnel caused by outdated information for collective decision-making, which can lead to safety risks and equipment breakdowns. Third, security of data and efficient resource management are difficult in the absence of limited access for each user.

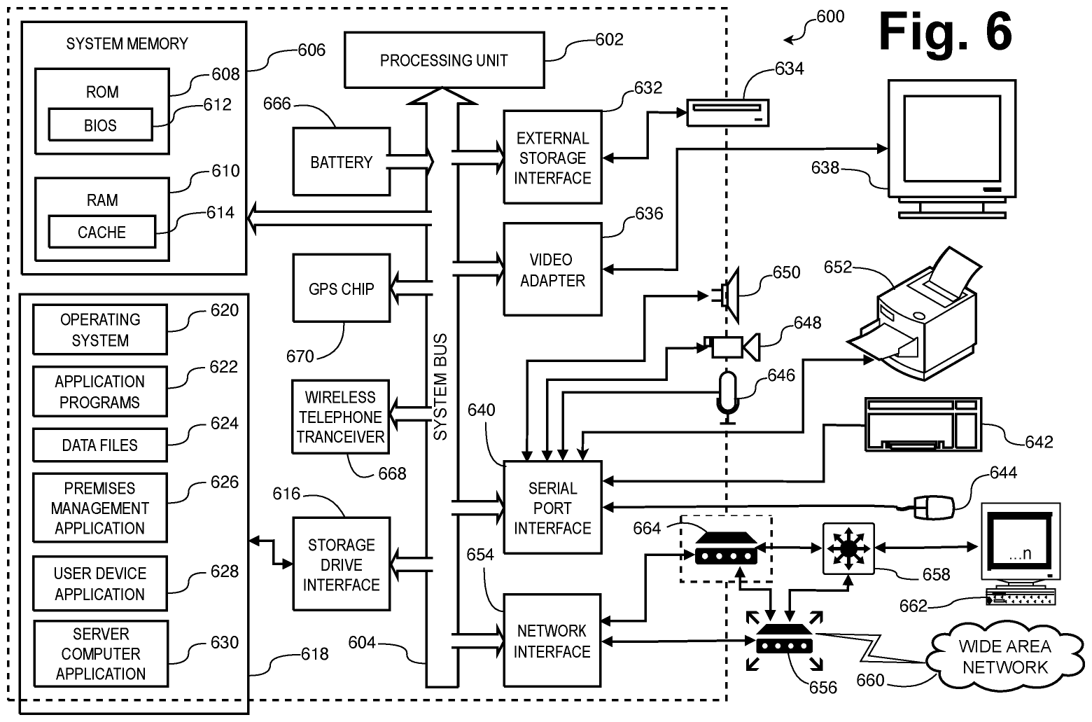

An exemplary computer system 600 embodying the access control device implementing the processes performed thereby as described above is depicted in FIG. 6. The computer system 600 embodying the access control device may be special purpose computer device, or it may be one or more of a personal computer (PC), a workstation, a notebook or portable computer, a tablet computer, a smart phone device, a video gaming device, or other computer device, with internal processing and memory components as well as interface components for connection with external input, output, storage, network, and other types of peripheral devices, particularly configured to perform the functions described herein. Internal components of the computer system 600 in FIG. 6 embodying the access control device 664 are shown within the dashed line and external components are shown outside of the dashed line. Components that may be internal or external are shown straddling the dashed line. The access control device 664 is shown encompassed by the dashed line to both indicate that the internal components are within it, and also to indicate the relationship between the access control device and the networks to which it is connected.

In any embodiment of the access control device described herein, the computer system 600 includes a processor 602 and a system memory 606 connected by a system bus 604 that also operatively couples various system components. There may be one or more processors 602, e.g., a single central processing unit (CPU), or a plurality of processing units, commonly referred to as a parallel processing environment (for example, a dual-core, quad-core, or other multi-core processing device). The system bus 604 may be any of several types of bus structures including a memory bus or memory controller, a peripheral bus, a switched-fabric, point-to-point connection, and a local bus using any of a variety of bus architectures. The system memory 606 includes read only memory (ROM) 608 and random access memory (RAM) 610. A basic input/output system (BIOS) 612, containing the basic routines that help to transfer information between elements within the computer system 600, such as during start-up, is stored in ROM 608. A cache 614 may be set aside in RAM 610 to provide a high-speed memory store for frequently accessed data.

A storage drive interface 616 may be connected with the system bus 604 to provide read and write access to a data storage drive 618, e.g., a magnetic hard disk drive or a solid state drive for nonvolatile storage of applications, files, and data. A number of program modules and other data may be stored on the storage drive 618, including an operating system 620, one or more application programs 622, and related data files 624. If the computer system 600 is an access control device, an access management application 626 implementing the access and transmission protocols described herein may be stored in the storage drive 618. Alternately, if the computer system is a mobile user device, a user device application 628 can be provided thereon which cooperates and communicates with the access management program 626 on the access control device. As another alternative, if the computer system 600 is a remote computer server, such as a proxy server or a database server, corresponding server computer applications 630 for coordinating, interacting, and communicating with the access management application 626 operating on the access control device. Note that the storage drive 618 may be either an internal component or an external component of the computer system 600 as indicated by the storage drive 618 straddling the dashed line in FIG. 6.

In some configurations, there may be both an internal and an external storage drive. For example, one or more external storage drives 634 may be connected with the system bus 604 via an external storage interface 632 to provide read and write access to the external storage drive 634 initiated by other components or applications within the computer system 600. (In some embodiments, external storage drives may also be connected to the system bus 604 via a serial port interface 640 further described below. Exemplary external storage drives 634 may include a magnetic disk drive for reading from or writing to a removable magnetic disk 632, tape, or other magnetic media, and/or an optical disk drive for reading from or writing to a removable optical disk 638 such as a CD-ROM, a DVD, or other optical media. The external storage drive 634 and any associated removable computer-readable media may be used to provide nonvolatile storage of computer-readable instructions, data structures, program modules, and other data for the computer system 600.

The computer system 600 may include a display device 638, e.g., a monitor, a television, or a projector, or other type of presentation device connected to the system bus 604 via an interface, such as a video adapter 636 or a video card. The computer system 600 may also include other peripheral input and output devices, which are often connected to the processor 602 and memory 606 through the serial port interface 640 that is coupled to the system bus 604. Input and output devices may also or alternately be connected to the system bus 604 by other interfaces, for example, a universal serial bus (USB), an IEEE 1394 interface (“Firewire”), a parallel port, or a game port. A user may enter commands and information into the computer system 600 through various input devices including, for example, a keyboard 642 and pointing device 644, for example, a computer mouse. Other input devices (not shown) may include, for example, a microphone 646, a digital video camera 648, a digital camera, a joystick, a game pad, a tablet, a touch screen device, a satellite dish, a scanner, or a facsimile machine.

Output devices may include one or more loudspeakers 650 for presenting the audio performance of the sender. Audio devices, for example, external speakers 650 or a microphone 646, may alternatively be connected to the system bus 604 through an audio card or other audio interface (not shown). Other output devices may include, for example, a printer 652, a plotter, a photocopier, a photo printer, a facsimile machine, and a press. In some implementations, several of these input and output devices may be combined into single devices, for example, a printer/scanner/fax/photocopier. It should also be appreciated that other types of computer-readable media and associated drives for storing data, for example, magnetic disks or flash memory drives, may be accessed by the computer system 600 via the serial port interface 644 (e.g., USB) or similar port interface.

As previously described herein, the computer system 600 embodying the access control device 664 may include a battery 666 for provision of backup power in a case of general or local power outage or emergency. The access control device 664 may further include a wireless telephone transceiver 668 for provision of external communication for premises operator communication or remote vendor access in a case of local network outage or emergency. The access control device 664 may additionally include a GPS chip 670 to provide location information about the device, e.g., for security purposes as described herein. Location information identified by the GPS chip 670 may be used to enact security features for the access control device 664 as previously described herein.

The computer system 600 may operate in a networked environment using logical connections through a network interface 654 coupled with the system bus 604 to communicate with one or more remote devices. The logical connections depicted in FIG. 6 include a local-area network (LAN) 658 and a wide-area network (WAN) 660. Such networking environments are commonplace in home networks, office networks, enterprise-wide computer networks, and intranets. These logical connections may be achieved by a network access device 656 coupled to or integral with the computer system 600. As depicted in FIG. 6, the network access device 656 is operating as both a router for directing traffic on the LAN 658 may use a router 656 or hub, either wired or wireless, internal or external, to connect with remote devices, e.g., a remote computer 658, similarly connected on the LAN 658. The remote computer 658 may be another personal computer, a server, a client, a peer device, or other common network node, and typically includes many or all of the elements described above relative to the computer system 600.

To connect with a WAN 660, the computer system 600 the network access device typically includes a modem for establishing communications over the WAN 660. However, in some embodiments, the modem for external network connections and the router for local network connections may be separate components. Most often the WAN 660 may be the Internet. However, in some instances the WAN 660 may be a large private network spread among multiple locations, or a virtual private network (VPN). The modem component of the network access device may be a telephone modem, a high-speed modem (e.g., a digital subscriber line (DSL) modem), a cable modem, or similar type of communications device. The network access device 656 with modem is connected to the system bus 604 via the network interface 654. In alternate embodiments the network access device 656 may be connected via the serial port interface 644. It should be appreciated that the network connections shown are exemplary and other means of and communications devices for establishing a network communications link between the computer system and other devices or networks may be used.

The technology described herein may be implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

The technology described herein may be implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM, DVD, or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, or any combination thereof, then the coaxial cable, fiber optic cable, twisted pair, DSL, or wireless technologies such as infrared, radio, and/or microwave are included in the definition of medium. Disk and disc, as used herein, include any combination of compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with this disclosure may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, and/or state machine. A processor may also be implemented as a combination of computing devices, for example, a combination of a DSP and a microprocessor, multiple microprocessors, one or more microprocessors in conjunction with a DSP core, and/or any combination thereof.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Furthermore, while various embodiments have been described and/or illustrated here in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may permit and/or instruct a computing system to perform one or more of the exemplary embodiments disclosed here.

The process parameters, actions, and steps described and/or illustrated in this disclosure are given by way of example only and can be varied as desired. For example, while the steps illustrated and/or described may be shown or discussed in a particular order, these steps do not necessarily need to be performed in the order illustrated or discussed. The various exemplary methods described and/or illustrated here may also omit one or more of the steps described or illustrated here or include additional steps in addition to those disclosed. Similarly, the detailed description may include specific details for the purpose of providing an understanding of the described systems, structures, or apparatus. However, it may be that such systems, structures, or apparatus can be implemented without such specific details. For example, in some instances, well-known structures and apparatuses are shown in block diagram form to provide focus to new aspects in the described examples.

In an example implementation, a method is provided within a computer system connected within a network for controlling access to information about one or more assets or locations within a premises. The method includes receiving within a premises management system operating on the network a user identifier associated with an individual user from a user device; authenticating access rights of the user to connect with the premises management system based upon the user identifier; identifying a role of the user based upon the user identifier; receiving a unique identifier from a scan by the user device of a smart code physically associated with one of the assets or locations; identifying permissions held by the user to access information related to the one of the assets or locations based upon a combination of both the role and the unique identifier associated with the one of the assets or locations; requesting information related to the one of the assets or locations from a data storage device connected to the network, wherein a storage location of the information on the data storage device is associated with the unique identifier; receiving a subset of the information about the one asset or location from the data storage device limited to information authorized for release to the user based upon the permissions; and transmitting the subset of the information about the one asset or location to the user device.

In another example implementation of the method, the smart code is a quick-response code image and the unique identifier is encoded within the quick-response code image.

In another example implementation of the method, the smart code is a near field communication tag and the unique identifier is stored as data within the near field communication tag.

In another example implementation, the method further includes transmitting a notification to the user device including a request to the user of the user device to perform a service with respect to another of the one more asserts or locations based upon the identified role of the user and, optionally, the identified permissions held by the user.

In another example implementation, the method further includes providing direction to the user to physically locate the another asset or location within the premises.

In another example implementation, the method further includes receiving a request for the service of the another asset or location at the premises management system from another user device, wherein the request for service includes the unique identifier associated with the another asset or location.

In another example implementation, the method further includes assigning a work order to the another user based further upon the request for service from the another user device.

In another example implementation, the method further includes receiving sensor data from respective assets among the one or more assets or location within the premises management system over the network; and storing the sensor data as the information associated with the respective assets within the data storage device.

In another example implementation, the method further includes receiving task log information from the user device documenting a service performed with respect to the one of the assets or locations; and storing the task log information in the data storage device as part of the information associated with the one of the assets or locations.

In another example implementation, the method further includes establishing, upon completion of the authenticating, a secure communication connection between the user device and the data storage device for real-time transmission of the subset of the information to the user device and receipt of related data from the user device.

In an example implementation, the techniques described herein relate to a premises management system for controlling access to information about one or more assets or locations within a premises. The system includes a local area network associated with the premises; a proxy computer communicatively connected to the local area network; a data storage device communicatively connected to the local area network; an access control device, including a computing processor and a memory device, connected to the local area network and configured to securely manage access to and communication within and across the local area network, wherein the memory storage device is configured with instructions which, when executed by the computing processor, cause the computing processor to receive a communication over the local area network from a user device within the premises a user identifier associated with an individual user; authenticate access rights of the user to connect with the premises management system based upon the user identifier; identify a role of the user based upon the user identifier; receive a unique identifier from a scan by the user device of a smart code physically associated with one of the assets or locations; identify permissions held by the user to access information related to the one of the assets or locations based upon a combination of both the role and the unique identifier associated with the one of the assets or locations; request information related to the one of the assets or locations from a data storage device connected to the network, wherein a storage location of the information on the data storage device is associated with the unique identifier; receive a subset of the information about the one asset or location from the data storage device limited to information authorized for release to the user based upon the permissions; and transmit the subset of the information about the one asset or location to the user device.

In another example implementation of the system, the smart code is a quick-response code image and the unique identifier is encoded within the quick-response code image.

In another example implementation of the system, the smart code is a near field communication tag and the unique identifier is stored as data within the near field communication tag.

In another example implementation of the system, the memory storage device is further configured with instructions which, when executed by the computing processor, cause the computing processor to further transmit a notification to the user device including a request to the user of the user device to perform a service with respect to another of the one more asserts or locations based upon the identified role of the user and, optionally, the identified permissions held by the user.

In another example implementation of the system, the memory storage device is further configured with instructions which, when executed by the computing processor, cause the computing processor to further provide direction to the user to physically locate the another asset or location within the premises.

In another example implementation of the system, the memory storage device is further configured with instructions which, when executed by the computing processor, cause the computing processor to further receive a request for the service of the another asset or location at the premises management system from another user device, and wherein the request for service includes the unique identifier associated with the another asset or location.

In another example implementation of the system, the memory storage device is further configured with instructions which, when executed by the computing processor, cause the computing processor to further assigning a work order to the another user based further upon the request for service from the another user device.

In another example implementation of the system, the memory storage device is further configured with instructions which, when executed by the computing processor, cause the computing processor to further receive sensor data from respective assets among the one or more assets or location within the premises management system over the network; and store the sensor data as the information associated with the respective assets within the data storage device.

In another example implementation of the system, the memory storage device is further configured with instructions which, when executed by the computing processor, cause the computing processor to further receive task log information from the user device documenting a service performed with respect to the one of the assets or locations; and store the task log information in the data storage device as part of the information associated with the one of the assets or locations.

In another example implementation of the system, the memory storage device is further configured with instructions which, when executed by the computing processor, cause the computing processor to further establish, upon completion of the authentication, a secure communication connection between the user device and the data storage device for real-time transmission of the subset of the information to the user device and receipt of related data from the user device.

The detailed description set forth above in connection with the appended drawings describes examples and does not represent the only instances that may be implemented or that are within the scope of the claims. The terms “example” and “exemplary,” when used in this description, mean “serving as an example, instance, or illustration,” and not “preferred” or “advantageous over other examples.” Any disclosure of components contained within other components or separate from other components should be considered exemplary because multiple other architectures may potentially be implemented to achieve the same functionality, including incorporating all, most, and/or some elements as part of one or more unitary structures and/or separate structures.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC, or A and B and C.

The above specification, examples and data provide a complete description of the structure and use of exemplary embodiments of the invention as defined in the claims. Although various embodiments of the claimed invention have been described above with a certain degree of particularity, or with reference to one or more individual embodiments, other embodiments using different combinations of elements and structures disclosed herein are contemplated, as other iterations can be determined through ordinary skill based upon the teachings of the present disclosure. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A method within a computer system connected within a network for controlling access to information about one or more assets or locations within a premises comprising
receiving within a premises management system operating on the network a user identifier associated with an individual user from a user device;
authenticating access rights of the user to connect with the premises management system based upon the user identifier;
identifying a role of the user based upon the user identifier;
receiving a unique identifier from a scan by the user device of a smart code physically associated with one of the assets or locations;
identifying permissions held by the user to access information related to the one of the assets or locations based upon a combination of both the role and the unique identifier associated with the one of the assets or locations;
requesting information related to the one of the assets or locations from a data storage device connected to the network, wherein a storage location of the information on the data storage device is associated with the unique identifier;
receiving a subset of the information about the one asset or location from the data storage device limited to information authorized for release to the user based upon the permissions; and
transmitting the subset of the information about the one asset or location to the user device.

2. The method of claim 1, wherein the smart code is a quick-response code image and the unique identifier is encoded within the quick-response code image.

3. The method of claim 1, wherein the smart code is a near field communication tag and the unique identifier is stored as data within the near field communication tag.

4. The method of claim 1 further comprising transmitting a notification to the user device including a request to the user of the user device to perform a service with respect to another of the one more asserts or locations based upon the identified role of the user and, optionally, the identified permissions held by the user.

5. The method of claim 4 further comprising providing direction to the user to physically locate the another asset or location within the premises.

6. The method of claim 4 further comprising receiving a request for the service of the another asset or location at the premises management system from another user device, wherein the request for service includes the unique identifier associated with the another asset or location.

7. The method of claim 6 further comprising assigning a work order to the another user based further upon the request for service from the another user device.

8. The method of claim 1 further comprising
receiving sensor data from respective assets among the one or more assets or location within the premises management system over the network; and
storing the sensor data as the information associated with the respective assets within the data storage device.

9. The method of claim 1 further comprising
receiving task log information from the user device documenting a service performed with respect to the one of the assets or locations; and
storing the task log information in the data storage device as part of the information associated with the one of the assets or locations.

10. The method of claim 1 further comprising establishing, upon completion of the authenticating, a secure communication connection between the user device and the data storage device for real-time transmission of the subset of the information to the user device and receipt of related data from the user device.

11. A premises management system for controlling access to information about one or more assets or locations within a premises comprising
a local area network associated with the premises;
a proxy computer communicatively connected to the local area network;
a data storage device communicatively connected to the local area network;
an access control device, including a computing processor and a memory device, connected to the local area network and configured to securely manage access to and communication within and across the local area network, wherein
the memory storage device is configured with instructions which, when executed by the computing processor, cause the computing processor to
receive a communication over the local area network from a user device within the premises a user identifier associated with an individual user;
authenticate access rights of the user to connect with the premises management system based upon the user identifier;
identify a role of the user based upon the user identifier;
receive a unique identifier from a scan by the user device of a smart code physically associated with one of the assets or locations;
identify permissions held by the user to access information related to the one of the assets or locations based upon a combination of both the role and the unique identifier associated with the one of the assets or locations;
request information related to the one of the assets or locations from a data storage device connected to the network, wherein a storage location of the information on the data storage device is associated with the unique identifier;
receive a subset of the information about the one asset or location from the data storage device limited to information authorized for release to the user based upon the permissions; and
transmit the subset of the information about the one asset or location to the user device.

12. The system of claim 1, wherein the smart code is a quick-response code image and the unique identifier is encoded within the quick-response code image.

13. The system of claim 1, wherein the smart code is a near field communication tag and the unique identifier is stored as data within the near field communication tag.

14. The system of claim 1, wherein the memory storage device is further configured with instructions which, when executed by the computing processor, cause the computing processor to further transmit a notification to the user device including a request to the user of the user device to perform a service with respect to another of the one more asserts or locations based upon the identified role of the user and, optionally, the identified permissions held by the user.

15. The system of claim 14, wherein the memory storage device is further configured with instructions which, when executed by the computing processor, cause the computing processor to further provide direction to the user to physically locate the another asset or location within the premises.

16. The system of claim 14, wherein the memory storage device is further configured with instructions which, when executed by the computing processor, cause the computing processor to further receive a request for the service of the another asset or location at the premises management system from another user device, and wherein the request for service includes the unique identifier associated with the another asset or location.

17. The system of claim 16, wherein the memory storage device is further configured with instructions which, when executed by the computing processor, cause the computing processor to further assigning a work order to the another user based further upon the request for service from the another user device.

18. The system of claim 1, wherein the memory storage device is further configured with instructions which, when executed by the computing processor, cause the computing processor to further
receive sensor data from respective assets among the one or more assets or location within the premises management system over the network; and
store the sensor data as the information associated with the respective assets within the data storage device.

19. The system of claim 1, wherein the memory storage device is further configured with instructions which, when executed by the computing processor, cause the computing processor to further
receive task log information from the user device documenting a service performed with respect to the one of the assets or locations; and
store the task log information in the data storage device as part of the information associated with the one of the assets or locations.

20. The system of claim 1, wherein the memory storage device is further configured with instructions which, when executed by the computing processor, cause the computing processor to further establish, upon completion of the authentication, a secure communication connection between the user device and the data storage device for real-time transmission of the subset of the information to the user device and receipt of related data from the user device.
